(19) United States
(12) Patent Application Publication
(10) Pub. No.: US 2013/0325521 A1
(43) Pub. Date: Dec. 5, 2013

(54) SHARED VEHICLE RENTAL SYSTEM INCLUDING VEHICLE AVAILABILITY DETERMINATION

(71) Applicants: Akhtar Jameel, Palo Alto, CA (US); Yu-Shan Fung, Los Altos, CA (US); John Laxson, San Francisco, CA (US); Benjamin Stabler, Stanford, CA (US)

(72) Inventors: Akhtar Jameel, Palo Alto, CA (US); Yu-Shan Fung, Los Altos, CA (US); John Laxson, San Francisco, CA (US); Benjamin Stabler, Stanford, CA (US)

(21) Appl. No.: 13/482,434

(22) Filed: May 29, 2012

(51) Int. Cl. G06Q 10/02

(52) U.S. Cl. 705/5

(57) ABSTRACT

Techniques and structures are disclosed relating to the rental of vehicles owned by different owners (i.e., a peer to peer vehicle network). Each owner may have his or her own set of rental criteria associated with a particular vehicle. Prospective drivers may have to meet (or choose from) this criteria to be able to rent a vehicle. Drivers may be able to choose a vehicle for rent based on a distance from one or more vehicles (e.g., closer vehicles are displayed higher in search results), price, or other factors. Messages and alerts may be exchanged between a server that implements a vehicle rental system and owner, driver, and/or vehicle computing devices. Location information about the vehicles is collected at the server, and a driver may be able to see the actual location of a vehicle for an upcoming rental. Vehicles may be remotely unlocked so that a driver can use the vehicle with keyless entry.

### RELATED CASES

This application is being co-filed with another application having the same assignee. This application is entitled “SHARED VEHICLE RENTAL SYSTEM INCLUDING TRANSMISSION OF RESERVATION INFORMATION AND TARGETED ADVERTISING,” and its content is herein incorporated by reference in its entirety.

### BACKGROUND

1. Technical Field

This disclosure relates to vehicle reservation and tracking technology, and more particularly, relates to techniques and structures allowing owners to register their vehicles and rent them out to individual drivers (who could belong to a club) according to specified criteria. Various other functions for a rental network of different vehicles are also described.

2. Description of the Related Art

A vehicle may typically be rented from a large company that owns a fleet of vehicles, such as ZIPCAR, Automobile OEMs, DAIMLER, BMW, GM, etc. A customer will then interact with a single owner (the company) in order to make a rental. The vehicle rental company may stockpile large numbers of vehicles at relatively few locations, such as major airports, for example. A vehicle rental location may therefore be many miles away from a prospective driver. It may be impractical or prohibitively expensive for a driver to use a vehicle from a typical commercial rental company for a short period of time, such as a one hour shopping trip to the grocery store.

In addition to vehicle fleets owned by a typical rental company, however, a large number of other privately owned vehicles are in existence. These vehicles are typically not available to be rented. These vehicles are generally owned by an individual owner (or perhaps by a couple), and may often go unused for long periods of time.

Allowing these underutilized, privately owned vehicles to be rented would benefit vehicle owners with additional income. Further, vehicle drivers in such a system might have additional rental opportunities that would not ordinarily be available or affordable via a typical vehicle rental company.

### SUMMARY

Structures and techniques are described in this application that may allow for the rental of vehicles owned by a plurality of different owners. Each owner may specify one or more rental criteria for his or her particular vehicle, such as price, time of rental, rental pick up or drop off location, etc.

An owner may register his or her vehicle with a server so that it may be rented in some embodiments. Registration may require an identity of the vehicle owner, a description of the vehicle, and one or more rental criteria for that vehicle. The server may then store this registration information for future use in the rental system.

A vehicle rental inquiry may be received at a server in one embodiment, and one or more matching vehicles (for which a set of owner specified criteria has been met) may be presented graphically or as a list to a prospective driver. Vehicles may be ordered, in one embodiment, according to their distance from the driver. The driver may then select one of the vehicles for a short or long term rental.

A vehicle may be associated with one or more geographic zones. In one embodiment, the vehicle is ordinarily parked in one location (which may be the basis for a “home zone”) and the driver is expected to pick up and drop off the vehicle within this zone. Other embodiments are possible and contemplated, however.

Vehicle hardware may be pre-configured or configured to receive reservation information and/or to learn control operations (such as use of the horn and door locks) that may facilitate sharing of the vehicle. For example, the horn may be used to remotely locate a vehicle, while the locks may be operated to give an operator keyless entry, and/or lights and parking. In some embodiments, a “key exchange” model may be used, in which aftermarket hardware is unnecessary.

Vehicle location and other information may be transmitted from a vehicle to a server, owner, driver, or other party. This information may be used to determine whether a vehicle is available for rent in response to a particular inquiry, or to display a location of a vehicle to an owner or driver, for example. Other alerts, messages, and communications (such as rental confirmations, etc.) may also be sent.

The teachings of this disclosure and the claims, however, are expressly not limited by the features, embodiments, and/or benefits discussed in the summary above.

### BRIEF DESCRIPTION OF THE DRAWINGS

FIG. 1 is a diagram showing one embodiment of a system overview in which a server is in communication with user computing devices and vehicles available for rent.

FIG. 2A is a diagram of one embodiment of an exemplary login screen for a vehicle rental system.

FIG. 2B is a diagram of one embodiment of an exemplary home screen that may be presented after a user has logged in.

FIG. 2C is a diagram of one embodiment of a screen in which a user can reserve a vehicle.

FIG. 2D is a diagram of one embodiment of a further screen usable in a vehicle reservation process.

FIG. 2E is a diagram of an embodiment of a screen in which an owner can manage his or her vehicle (availability, price, location, etc.).

FIG. 3 shows one embodiment of a screen relating to the use of geographic zones associated with a vehicle, including details of how zones may be used for the vehicle rental process.

FIG. 4 is a flow chart of one embodiment of a method for a vehicle reservation process.

FIG. 5A is a diagram illustrating the determination of rental vehicle availability based on distance factors.

FIG. 5B is a diagram illustrating one embodiment of vehicle rental pricing.

FIG. 6 is a block diagram illustrating an overview of one hardware configuration for a vehicle usable in a vehicle rental system.

FIG. 7 is a block diagram illustration an embodiment of vehicle-customer interface units that may correspond to the embodiment of FIG. 6.

FIGS. 8A-8B are two diagrams collectively illustrating an example of how a server may receive location information for a vehicle at different times.

FIG. 9 is a block diagram illustrating one embodiment of a computer system that may be used to implement a server system, user computing device, and/or rental vehicle computing device.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used herein, this term does not foreclose additional structure or steps. Consider a claim that recites: “a system comprising a processor and a memory . . . .” Such a claim does not foreclose the system from including additional components (e.g., interface circuitry, a graphics processing unit (GPU), etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue.

“First,” “Second,” etc. As used herein, these terms are used as labels for nouns that they precede unless otherwise noted, and do not imply any type of ordering (e.g., spatial, temporal, logical, etc.). For example, a “first” vehicle and a “second” vehicle can be used to refer to any two vehicles, and does not imply that one vehicle was entered into a system before or after the other (for example). In other words, “first” and “second” are descriptors.

“Based On” or “Based Upon.” As used herein, these terms are used to describe one or more factors that affect a determination. This term does not foreclose additional factors that may affect a determination. That is, a determination may be solely based on the factor(s) stated or may be based on one or more factors in addition to the factor(s) stated. Consider the phrase “determining A based on B.” While B may be a factor that affects the determination of A, such a phrase does not foreclose the determination of A from also being based on C. In other instances, however, A may be determined based solely on B.

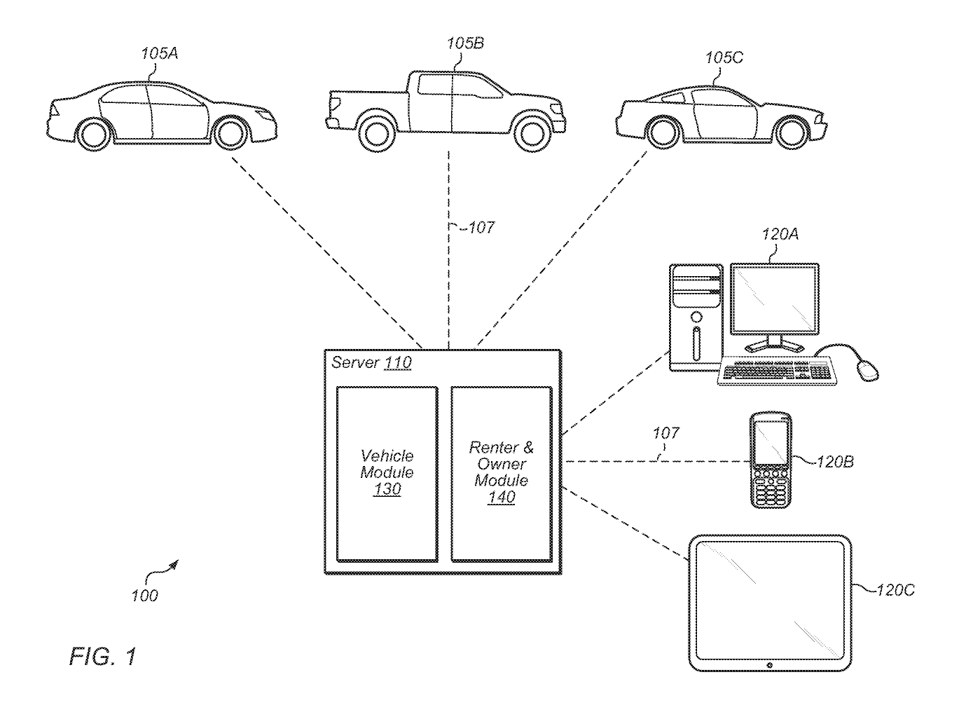

Turning now to FIG. 1, a diagram 100 depicting one embodiment of a system overview is shown. In this figure, vehicles 105A-105C are in communication with a server 110 via network connections 107. Server 110 is also shown as being in communication with a plurality of user computing devices 120A-120C.

As shown, vehicles 105A-105C include an assortment of cars and trucks. These vehicles may be of different makes and models, and may have a variety of different features. However, a vehicle 105 may be any type of vehicle in various embodiments. Thus, in other embodiments, a vehicle 105 may be a motorcycle, scooter, all-terrain vehicle, bicycle, boat, snowmobile, airplane, or other type of transportation device. Further, in such embodiments, various features described herein may be adapted in accordance with properties or requirements for a particular vehicle type, including special licensing requirements, location requirements, etc.

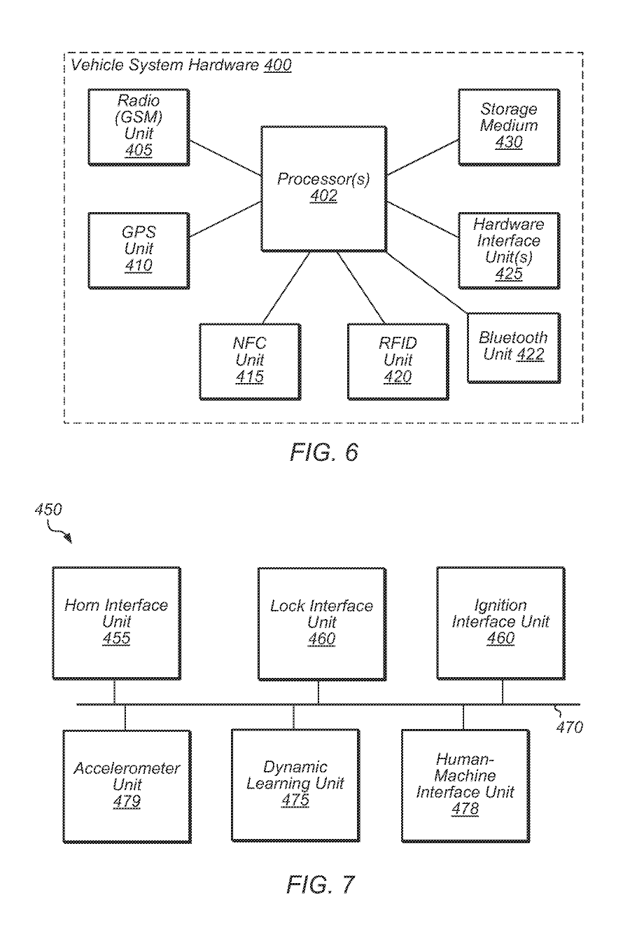

As shown, each of vehicles 105A-105C is configured to communicate with server 110 via a network connection 107. In one embodiment, this connection is a connection made via a telecommunication network. Network connection 107 may be a wireless connection in some embodiments, and may intermittent. Vehicles 105 may include various hardware and/or software, as further described below with respect to FIGS. 6 and 7, for example. As shown, server 110 is also configured to communicate with a plurality of user computing devices 120. In various embodiments, user computing devices 120 may be a desktop computer (120A), a mobile phone device and/or smart phone (120B), a tablet computing device (120C), or any other type of computing device.

Server 110 may include one or more hardware and software modules. As shown, server 110 includes modules 130 and 140. As used herein, the term “module” may refer to data and/or executable instructions stored on a computer-readable storage medium. Vehicle module 130 may, for example, include instructions that relate to vehicle and/or driver aspects, and may coordinate bi-directional communication with vehicles 105. Driver and owner module 140, as shown, includes instructions that relate to interactions with user computing devices 120 (which may be operated by vehicle owners and vehicle drivers, for example).

### Overview of an Exemplary Vehicle Rental Transaction

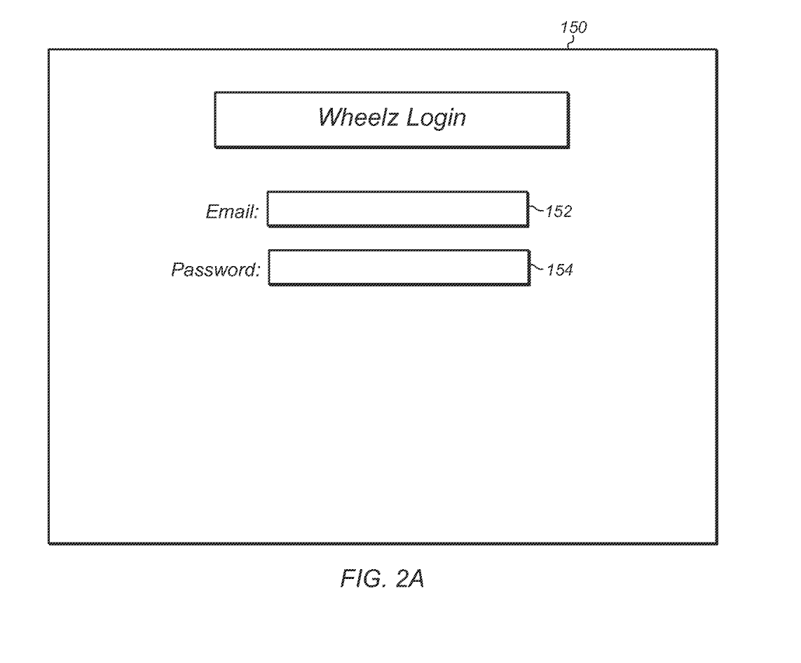

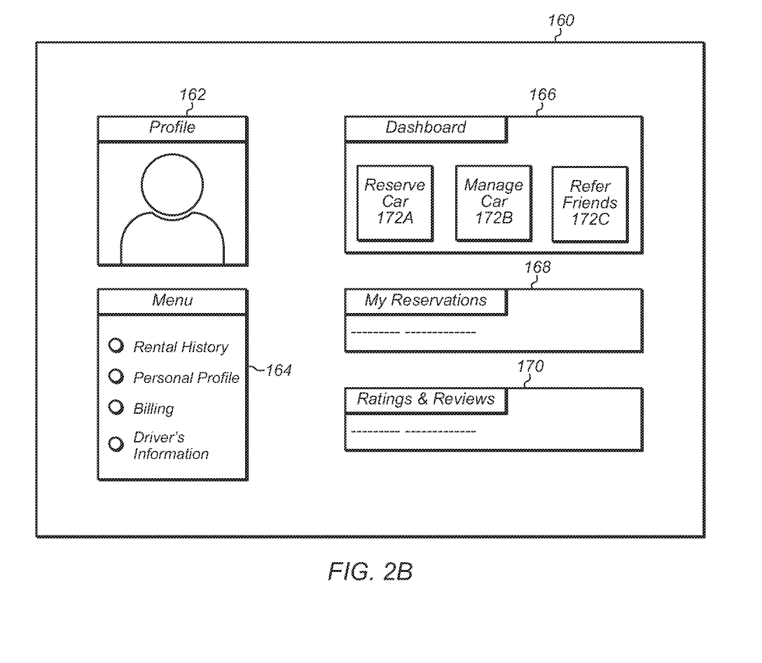

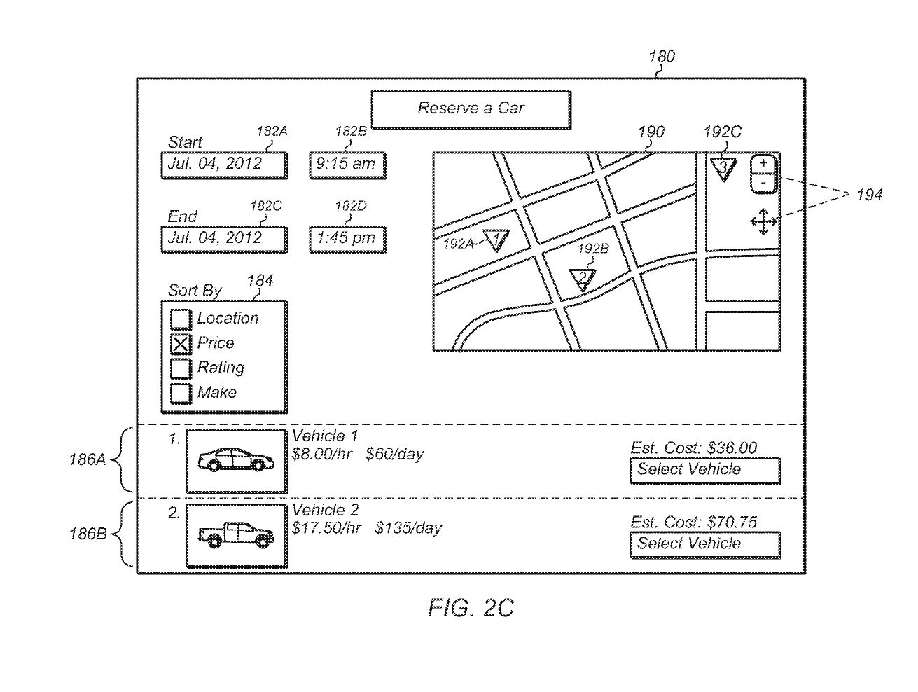

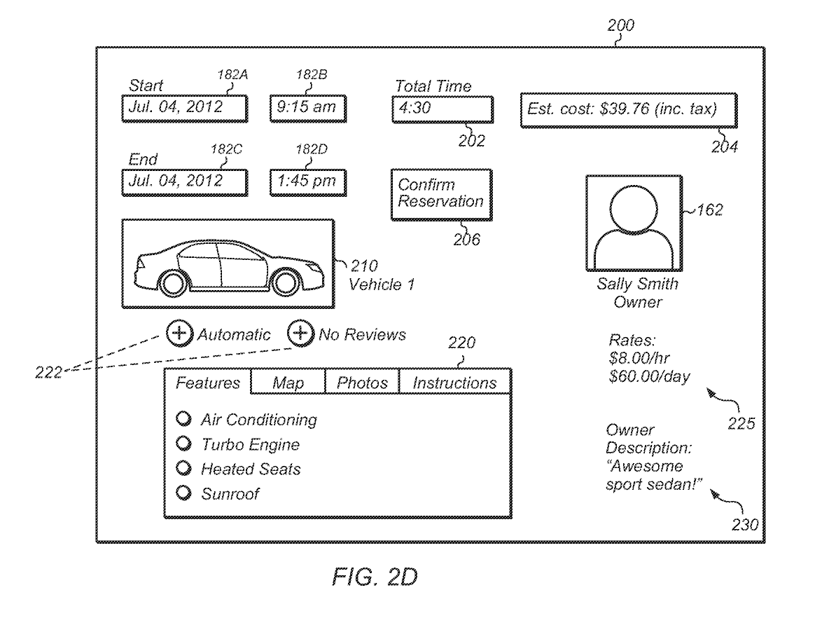

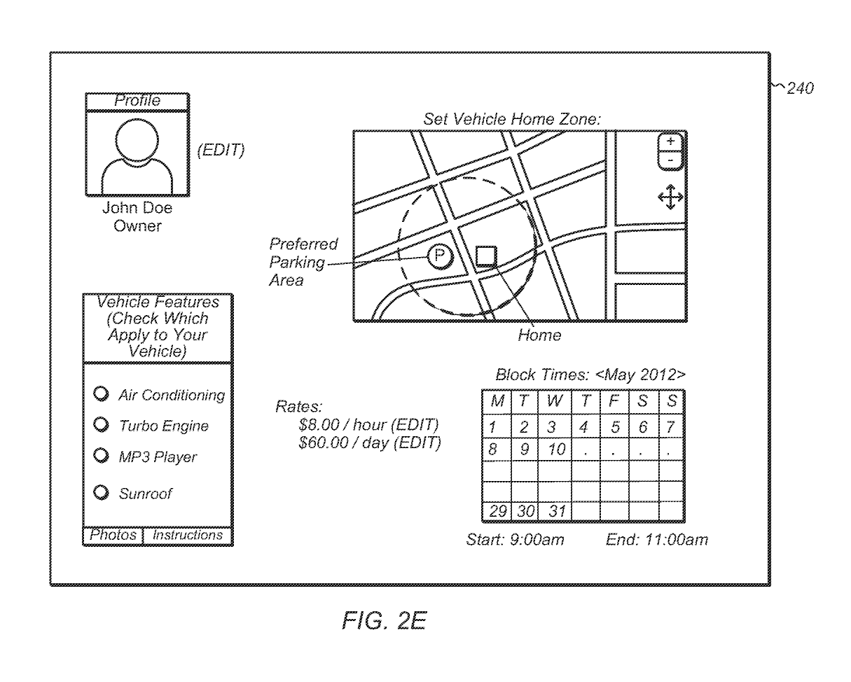

Referring now to FIGS. 2A-2D, display screen depictions 150, 160, 180, and 200 are shown. Collectively, these screens illustrate various aspects of an exemplary vehicle rental transaction. Screen depictions 150, 160, 180, and 200 show a web application from the perspective of a user computing device in the embodiments of FIGS. 2A-2D.

In FIG. 2A, an exemplary login screen 150 is shown. In screen 150, a user must provide identifying information 152 and authentication information 154 (which are an email address and a password, in this embodiment). Screen 150 may be used in association with an Internet web site, such as WHEELZ.COM, for example.

Turning to FIG. 2B, an exemplary home screen 160 is shown. Home screen 160 may be presented to a user, in various embodiments, after the user has logged in. Home screen 160 may include profile information 162 (including a user picture and/or other information), a menu 164, another “dashboard” menu 166, reservation information 168, and ratings and/or review information 170. Dashboard 166 may include various action buttons 172 selectable to begin new processes (as shown, these buttons include “reserve a car” button 172A, “manage a car” button 172B, and “refer friends” button 172C).

Turning now to FIG. 2E, an exemplary screen shot of the ability to set owner preferences is shown. In this figure, the owner's picture is in the upper left corner, and they owner may edit it accordingly. This picture may be displayed to prospective drivers during the rental process, for example. In the lower left corner, a “vehicle features” dialog is shown, in which an owner may indicate features that a vehicle has (such as air conditioning, etc.) In some embodiments, an owner may describe the feature him or herself if a standard checkbox is not provided. Features are of course not limited to the ones shown in screen shot 240. An owner may upload photos of the vehicle using the “vehicle features” dialog box. These photos also may be shown to another prospective driver. An owner may also specify special instructions for the vehicle using this dialog box (e.g., notes on where or how to park the vehicle, special requests or requirements, etc.)

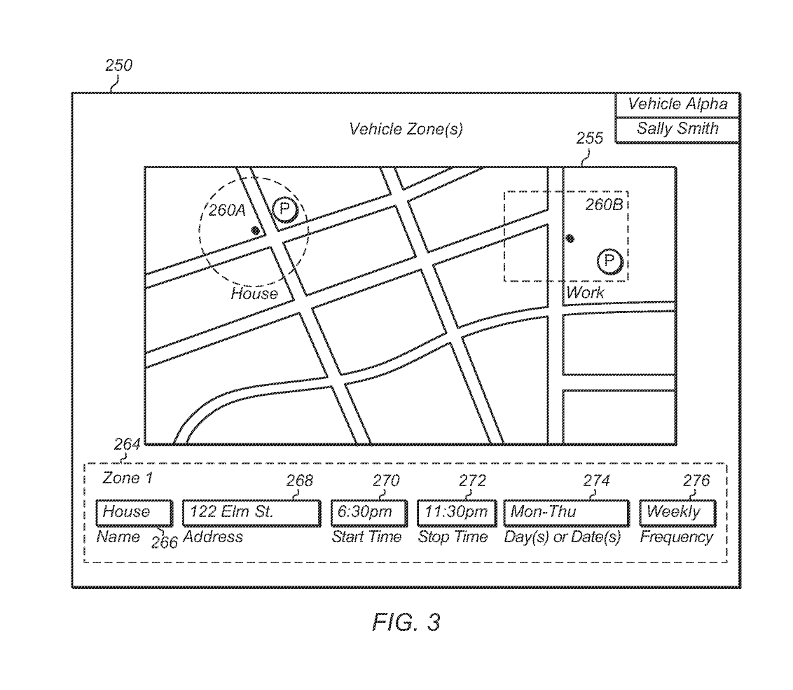

Screen 240 also allows the owner to set a “home zone” for a vehicle, including the ability to set a preferred parking location. The location of preferred parking, a home (or other location), may be changed by the owner in accordance with other features described in this specification (e.g., as mentioned relative to FIG. 3). Vehicle rates may also be set by an owner in screen 240 (for example, specifying per hour or per diem rates).

Further, screen 240 may allow an owner to “block out” one or more periods of time for a vehicle—preventing other from using it. This may be done using a calendar and the owner entering start and stop dates and times. In some embodiments, times can be blocked out on an ongoing basis (e.g., every weekday from 9:30 am to 1:30 pm, etc). More than one “block out” period can be specified for different vehicles. In one embodiment, instead of blocking out time, an owner may instead specify windows in which the vehicle is available (e.g., with the presumption that non-specified windows of time are when the owner would like the vehicle not to be available to others).

Turning back to FIG. 2C, a “reserve a car” screen 180 is shown. In this screen, a user can reserve a vehicle. The user may select a reservation start and reservation end, which may be specified by times and dates 182A-D. Vehicle information 186 may be displayed according to one or more selectable sorting criteria 184 (which, as shown, include vehicle features, location, price, and rating). A depiction of a map 190 is shown in the embodiment of FIG. 2C. Map 190 may include icons 192 showing the rental location(s) of one or more different vehicles 105. Navigation tools 194 may be used to change the area displayed by map 190 (e.g., zooming in or out, or causing the display to move in one or more directions). One or more portions of screen 180 may be selectable in order to start a car reservation process (e.g., such as icons 192 and/or one or more portions of vehicle information 186).

In FIG. 2D, a further vehicle reservation screen 200 is shown. Screen 200 includes additional details relating to a reservation process for a particular vehicle, and may be presented to a user after a user has made a selection on a previous screen (e.g., screen 180). In the embodiment of FIG. 2D, screen 200 is shown relative to a “Vehicle 1” that has been selected for rental. A total time 202 for the reservation may be displayed along with an estimated cost 204. A “confirm reservation” button 206 may confirm the user's rental, and allow Vehicle 1 to be reserved for the time period specified. The confirm reservation button may also cause a further screen (not depicted) to be displayed for final payment or to perform other aspects relating to the rental of Vehicle 1 (such as changing reservation time or duration).

Screen 200 may also include a picture 210 of Vehicle 1 and a display menu 220. Picture 210 may be uploaded by an owner in some embodiments Display menu 220 may display vehicle features, a map showing one or more locations for the vehicle, one or more photos of the vehicle, and/or particular instructions for the vehicle. Screen 200 may also include indicators 222 showing that Vehicle 1 is automatic and has had no reviews. Rate information 225 is shown in the embodiment of FIG. 2D, as is an owner description 230 of the vehicle. Owner profile information 162 is also shown in screen 200, and may include a picture of the owner and/or the owner's name.

Thus, several screens depicting aspects of a vehicle rental process have been described with respect to FIGS. 2A-2D. As further discussed below, however, many features and embodiments that may relate to such a vehicle rental process are described. For example, a computer system may determine whether one or more vehicles are available for rent based on a number of factors, including owner-specified preferences. Various communications between server 110, vehicles 105, and/or user computing devices 120 may be exchanged in different embodiments. Vehicles 105 may be installed with particular hardware and/or software to perform certain functions. Numerous other embodiments are also described herein.

### Detailed Features of Vehicle Reservation System

A vehicle rental inquiry may be received by server 110 in various embodiments, and in response, one or more vehicles may be determined to be available for rent. This determination may include vehicle rental criteria specified by vehicle owners (which server 110 is configured to store, in various embodiments). In one embodiment, each of a number of vehicles has a corresponding set of one or more rental criteria that may be specified by the owner of that vehicle.

As further discussed below, many different types of criteria may be specified by an owner. In various embodiments, a vehicle owner may specify one or more geographic zones associated with a vehicle (such as a “home zone”) that may be used to determine (possible along with other information) whether a given vehicle is available to be rented.

### Vehicle Zones

Turning to FIG. 3, a screen 250 is shown relating to the use of geographic zones associated with a vehicle. In general, and as used herein, a geographic zone refers to one or more particular geographic locations and/or one or more particular geographic areas. Geographic zones may be of varying size and shape in various embodiments. In some embodiments, a geographic zone is defined by one or more boundary lines and/or curves that connect three or more specific geographic locations (i.e., points on map). In some embodiments, a geographic location may include or be centered on a particular location such as an address, an intersection, landmark, or other geographic feature.

A vehicle may be associated, in some embodiments, with a geographic zone that is a “home zone” for that vehicle. In such an embodiment, the home zone is a “default” zone; thus, in these embodiments, the home zone may be selected by default (or without active input) for any purpose relating to geographic zones as consistent with this disclosure. In embodiments in which a vehicle is associated with only a single zone, the single zone is considered to be the home zone. In embodiments in which a vehicle may be associated with multiple zones, one of those zones may be designated as a home zone.

In the embodiment of FIG. 3, screen 250 may be shown on the display of a user computing device 120 or an operations console, and includes a map 255. Map 255 may have any or all of the features of map 190 in various embodiments (e.g., navigation, zoom in/zoom out, etc.). Two illustrations of geographic zones 260A and 260B are depicted on map 255. Note that in the embodiment of FIG. 3, a vehicle may have two or more zones associated with it; however, in other embodiments, a vehicle may only have a single zone associated with it.

Zones 260A and 260B, as shown, both include a center point. Zone 260A radiates outward from its central point in a circle having a radius of specified distance (e.g., feet, kilometers, miles, city blocks, etc.). Meanwhile, zone 260B is defined by a rectangular area of specified boundaries (e.g., length and width). Geographic zones, in some embodiments, may have one or more of their boundaries correspond to the path of a street, a municipal boundary (e.g., a city border), or another geographical boundary or feature (state line; city limits, boundary of a local, state or national park, etc.). A geographic zone may have any shape, in various embodiments.

Using a screen such as 250, a user may specify one or more geographic zones. Techniques described with regard to geographic zone selection (or definition) for screen 250 may be applied in various other embodiments and in other contexts consistent with this disclosure in order to define a geographic zone. In the embodiment of FIG. 3, screen 250 allows an owner (in this case, “Sally Smith”) to define one or more geographic zones associated with a particular vehicle (“Vehicle Alpha”). A “preferred parking” location may also be shown on screen 250 so that a driver can see the owner's preference and attempt to park the vehicle as close as possible.

In one embodiment, a geographic zone may be specified via a set of properties 264. Values for these properties may be entered and/or manipulated via one or more on-screen dialog boxes 266-276 in the embodiment shown. (Other dialog boxes or other input mechanisms not shown may also be used to specify a geographic zone). Using dialog box 266, the name of a zone may be entered. An address associated with the zone may be entered via dialog box 268. In one embodiment, a zone is initially placed on map 255 in response to the user entering a street address in dialog box 268. Further, in some embodiments, an address for a zone may correspond to a center point (or initial starting point) for that zone. Note that dialog box 268 may include a city, state, zip code, or other address information not depicted in FIG. 3.

In one embodiment, a user can manipulate geographic zone boundaries and/or locations using a computer mouse (or a touch screen or other type of input selection device). For example, a zone can be “dragged and dropped” in some embodiments to another part of map 255. In one embodiment, a user may thus be able to select the center point of zone 260A and move it to a different location on the map. The boundaries of a zone depicted on map 255 may also be adjusted by graphical manipulation of the depiction of a zone boundary. For example, a user may select the radius of zone 260A and make it smaller or larger (sometimes within pre-defined restrictions). Similar manipulations may also be made for zone 260B. Other techniques known to those of skill in the art may be used in order to specify boundaries and/or locations for a geographic zone.

In some embodiments, limits upon the size and/or shape of a geographic zone may be imposed (e.g., by an administrator of server 110). For example, a rule (stored by server 110) may specify that a zone may not be allowed to exceed a particular maximum or minimum total area. Other rules may stipulate that a zone is constrained directionally so that it cannot extend excessively far in a given direction (e.g., the zone may have a maximum/minimum width or maximum/minimum height, relative to a particular directional axis). Accordingly, in such an embodiment, a user might be prohibited from specifying a geographical zone that is more than twenty blocks wide along any one axis (e.g., east to west). Note that axes other than the cardinal north-south and east-west axes may be used to determining zone boundary restrictions in various embodiments. A given zone for a vehicle may thus be subject to one or more specified restrictions according to rules such as the above. In one embodiment, however, geographic zones are all the same size and/or the same shape. In another embodiment, different predefined shapes may be selected by a user (e.g., circle, elliptical, square, rectangle, etc.) Several different geographic zones of predefined size and/or shape may also be available to a user and/or driver in some embodiments (e.g.; a “small,” “medium,” and “large” zone size might be allowed). In one embodiment, a user can specify the boundaries of a zone by selection of various locations (points) on map 255. Boundary points and/or edges may also be “dragged and dropped” on map 255 to redefine a zone in some embodiments.

Time and/or date values (or constraints) may be associated with a zone in various embodiments. These time and/or date values may indicate, in these embodiments, time periods in which a vehicle is available to be rented. For example, a zone may be associated with a vehicle during certain times of day and/or days of the week. Dialog boxes 270-276 may be used to set such properties in the embodiment of FIG. 3. Particular start and stop times may be set via dialog boxes 270 and 272, for example. Particular days of the week, dates or date ranges, etc. may be specified using dialog box 274. A frequency setting may be applied in the embodiment of FIG. 3 using dialog box 276. For example, frequency might be set to a recurring value such as monthly, weekly, etc. Accordingly, a variety of information and/or preferences may be specified for a particular zone associated with a vehicle. Further note that in general, the selection and/or use of a given one of dialog boxes 266-276 (or any other user interaction element on various screens described herein) may cause one or more pop-up windows, drop-down menus, and/or other advanced input mechanisms to appear. Accordingly, input is not limited to the particular format(s) depicted in the figures accompanying this specification.

In one embodiment, for example, after a user completes entering a time and/or date range for a particular zone, a pop-up window may allow a user to enter additional time and/or date ranges if desired. Thus, a user could specify that a particular vehicle zone is associated with a time range on Saturdays from 9:00 am to 10:00 pm, as well as a shorter range on Sundays from 1:00 pm to 9:30 pm. Accordingly, in various embodiments, any number of date and/or time ranges may be associated with a particular geographic zone.

In one embodiment, a vehicle may have a single geographic zone associated with it, while in other embodiments, two or more different geographic zones may be associated with a vehicle. For example, as shown in FIG. 3, Vehicle Alpha has two zones 260A and 260B associated with it. An owner may set up multiple different zones for a particular vehicle in accordance with where the vehicle is ordinarily kept at different times of day, days of the week, months of the year, etc. For example, in one embodiment, a vehicle might have a first zone that corresponds to the owner's residential address (e.g., the “House” zone). This first zone might be associated with vehicle rental periods falling between Friday, 6:00 pm to Sunday, 11:30 pm, and Monday to Thursday, 6:30 pm to 11:30 pm. (Accordingly, in one embodiment, Vehicle Alpha would be available to be rented from zone 260A during those time periods.) Likewise, a second zone (“Work”) might correspond to the typical location of the owner's work address during the week, and might be associated with rental periods falling on or between Monday through Friday, 9:00 am to 5:00 pm.

In one embodiment, a particular vehicle rental may be associated with only one zone (i.e., a vehicle picked up from an owner's “Work” zone must also be returned to the Work zone, rather than a different one such as the “House” zone). In other embodiments, however, an owner may specify criteria allowing return of a vehicle to a location different than the zone in which the vehicle was picked up. Different zones may be set up in different geographic regions (e.g., different cities, states, and/or countries), and may correspond to a user's vacation or travel schedules, for example. Thus, an owner that regularly resides in Ohio from April to September and in Florida from October to March in Florida, for example, could have different zones corresponding to these locales. An owner that goes on a week long vacation (or work trip) out of the country might allow rental of her vehicle 24 hours a day while she is gone, but return to a normal (more restrictive) schedule upon completion of the trip. Note also that in some embodiments, different sets of owner preferences and/or rules may be applied to different zones. That is, any owner preference (or rental criterion) can be applied to one zone or to more than one zone in various embodiments. Accordingly, by specifying particular dates and/or times, an owner may set up any number of distinct periods for which a vehicle may be available for rent from one or more geographic zones.

### Vehicle Reservation Process

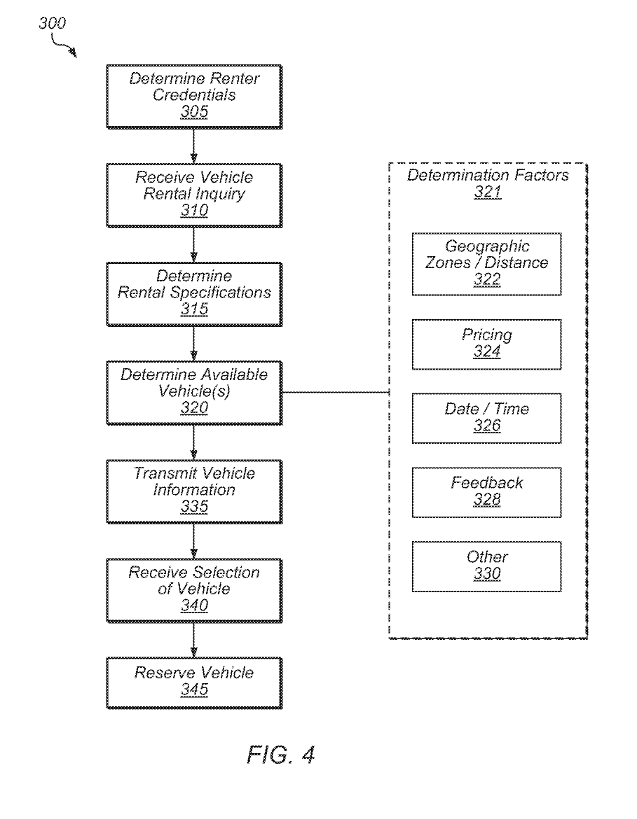

Turning now to FIG. 4, an exemplary vehicle reservation process 300 is shown. Process 300 may be implemented by server 110 (or another computer system and/or computing device) executing stored instructions. In some embodiments, one or more operations of process 300 may not be performed, or may be performed in an order different than the one shown, as consistent with this disclosure. Thus, in one embodiment, a computer-readable storage medium may include instructions executable to cause all operations of reservation process 300 to be performed, while in other embodiments, a computer-readable storage medium may include instructions executable to cause performance of some lesser number (or portions of) operations 305-345. In some embodiments, operations 305-345 may be performed by one or more software modules.

In operation 305, the credentials of a prospective driver are determined. This operation may include receiving (and authenticating) a login and/or password from a prospective driver (who may already be registered with a vehicle reservation system). In one embodiment, authentication may be performed by a third party, such as social networking website FACEBOOK.COM. (Note generally, that as used herein, the term “social networking website” includes a website to which a user registers using his or her name, and can then make interpersonal connections, which may be of one or more pre-specified types, to other users of that website. MYSPACE.COM, TWITTER.COM, and LINKEDIN.COM are other examples of social networking websites, while a general search engine site such as BING.COM would not be such a social networking website.) In one embodiment in which third party credentials are used for authentication, a user may log in to the third party site, and server 110 may be configured with a plugin or other software to receive authentication credentials from a computer system associated with the third party site. Thus, a third party site may transmit a security token or other information to server 110 indicating that a driver has been authenticated. Owner authentication, although not depicted in FIG. 4A, can be handled in a similar to driver authentication in various embodiments.

Operation 305 may also include authentication of a prospective driver's licensing credentials (e.g., during the registration process). To authenticate licensing information, server 110 may communicate with a government database or another server to check that a prospective driver currently has a valid license. In some embodiments, checking the validity of a license may be performed at registration. In other embodiments, license checking may be at occasional or periodic intervals, while in yet other embodiments, a licensing check may be performed substantially in real-time in association with a particular rental. A licensing check may determine if a user is rated for a particular vehicle, depending on that vehicle's requirements (e.g., commercial grade truck). If a prospective driver fails a licensing check, process 300 may be terminated with (or without) a message to the driver. The licensing check may include, in some embodiments, determining whether a prospective driver has a suspended license or civil and/or criminal violations, such as one or more citations within a given time period, or one or more arrests and/or convictions for criminal offenses such as driving under the influence). Additional checks may be performed, and may include verifying third party certifications and/or credentials. In some embodiments, while a vehicle reservation system managed by server 110 may specify minimum credentials, an owner may specify additional and/or heightened credentials as vehicle rental criteria. An insurance company or operating entity (e.g., WHEELZ) may also specify certain criteria. In the embodiment of FIG. 3, process 300 proceeds to operation 310 after driver credentials have been determined in operation 305. (Note: in various embodiments described herein, the terms “driver” and “owner” can be used interchangeably. So in one embodiment, operation 310 may occur after an owner's credentials have been verified).

A vehicle rental inquiry is received in operation 310. The vehicle rental inquiry may be received by server 110 from a user computing device 120 or by phone (voice) in various embodiments. A vehicle rental inquiry may specify a variety of information relating to a possible rental, such as time(s) of day, date(s), duration, location(s) (e.g., geographic zones), pricing, desired vehicle features, other information, and/or any combination thereof. In one embodiment, a prospective driver may enter this information via a web application that is running on a web browser or another application running on computing device 120. In some embodiments, user interaction with server 110 is performed via one or more web applications hosted by server 110. All or a portion of a vehicle rental inquiry may be received prior to (or in association with) the authentication of driver credentials in operation 305 in some embodiments. Accordingly, in one embodiment, a prospective driver can submit a vehicle rental inquiry before having to log in and be authenticated. In one embodiment, renter “preferred rentals” settings can be stored and re-used as part of a vehicle inquiry.

In operation 315, one or more rental specifications are determined. Rental specifications may be determined, in various embodiments, from information contained in a vehicle rental inquiry and/or from profile information associated with a particular prospective driver. A given rental specification may be expressed, in some embodiments, as a requirement or as a preference (or may be handled by server 110 as such). Thus, in some embodiments, a prospective driver may specify requirements and/or preferences that relate to vehicle features, pricing, geographic zones for rental, etc., for which one or more values may be determined from a vehicle rental inquiry and/or from user profile data. In some embodiments, certain vehicles may not be displayed as available for rent if a prospective driver has specified requirements that cannot be met, while in other embodiments, one or more vehicles may be offered to a driver even if not all requirements are met.

As one example, a vehicle rental inquiry may specify a start date, start time, end date, end time, and a preferred start location (e.g., an address and/or geographic zone). This start location may be a home zone for a driver in some embodiments. In addition, stored profile information for a prospective driver making the vehicle rental inquiry may specify that an automatic transmission is required for that prospective driver (as he or she may be unable to drive a manual transmission, for example). In some embodiments, any information that may be specified as a part of a vehicle rental inquiry may also be stored as a “default” setting in a prospective driver's profile information. In such an embodiment, server 110 may “auto populate” vehicle rental inquiry fields in accordance with stored preferences. Thus, in various embodiments, a given vehicle rental inquiry may be based on information that is currently specified by a prospective driver as well as being based on previously stored (profile) information. Operation 315 may therefore modify the received vehicle rental inquiry from operation 310 in one embodiment such that the modified vehicle rental inquiry includes additional and/or different information.

In operation 320, a determination is made as to whether one or more vehicles are available for rent. This determination may be based, in various embodiments, on one or more rental specifications of a prospective driver, one or more vehicle rental criteria of a vehicle owner, and/or one or more requirements that may be specified by an administrator of a vehicle rental system that is implemented by server 110. Accordingly, a number of factors 321 may be considered by server 110 in determining what vehicles, if any, may be available in response to an inquiry. Factors 321 upon which this determination may be based include including geographic zone and/or distance information 322; pricing information 324; rental date and/or time information 326; feedback information 328; and/or other information 330. If no vehicles are determined to be available, however, process 300 may exit at operation 320 with (or without) a message to a user.

Determining whether a given vehicle is available for rent may be based on one or more criteria specified by an owner or operator (e.g., WHEELZ). In some embodiments, an owner-specified criterion may be applicable to one or more specified vehicles, or may also be applicable as a universal preference for all vehicles associated with a particular owner. Note that as used herein, the term “determining one or more vehicles available for rent based on respective sets of vehicle rental criteria specified by a plurality of owners” refers to a determination that is based on at least two rental criterions respectively specified by at least two different owners of two different vehicles. The rental criterions referred to in this “determining” operation may relate to the same factor, or to different factors (e.g., a first owner-specified vehicle rental criterion may relate to the geographic zone of a vehicle, while a second owner-specified vehicle rental criterion may relate to a factor other than geographic zones). The term “determining one or more vehicles available for rent” may thus include a determination in which a first vehicle is determined to be available and a second vehicle is determined to be unavailable.

Owner-specified criteria that may affect the determination of whether a given vehicle is available for rent may include, in various embodiments:
rental price;
vehicle location (e.g., geographic zone);
existence of a specified relationship between the owner and a prospective driver (which may be defined via a social networking website in some embodiments);
feedback and/or approval ratings of a prospective driver;
licensing requirements;
vehicle proficiency requirements;
operator specified requirements such as maintenance; or
other requirements.

A determination of whether a given vehicle is available for rent is therefore based, in one embodiment, on a distance relationship between the given vehicle and a first geographic zone associated with a vehicle rental inquiry. A geographic zone may be associated with the vehicle rental inquiry in a variety of ways. For example, a prospective driver may specify an address in the vehicle rental inquiry, or an address or location may be determined from stored profile data, which server 110 may then use as a basis for determining boundaries of a geographic zone. (In other embodiments, the received address alone may be considered to be indicative of a geographic zone associated with the vehicle rental inquiry.) A prospective driver may also have profile information that specifies an address and/or a geographic zone, such as a “home zone.” (As used herein with respect to a driver, the term “home zone” refers to a “default” geographic zone that is associated with that driver. Vehicles and/or owners may likewise have “home zones” in various embodiments).

A geographic zone may be associated with a vehicle rental inquiry, in some embodiments, based on location information for a user computing device 120. For example, GPS coordinates (or other location information) of a portable computing device may be transmitted to server 110 when a prospective driver makes an inquiry. Accordingly, in some embodiments, a prospective driver may not have to enter location information when making an inquiry (as the location information may be sent to server 110 automatically). In another embodiment, a geographic zone associated with a vehicle rental inquiry may be the “home zone” of a prospective driver. Thus in some embodiments, server 110 may already possess information specifying a geographic zone associated with a vehicle rental inquiry (e.g., rather than having to receive that information from a perspective driver).

In one embodiment, a given vehicle may be determined to be available for rent based on whether there is an overlap between the area of a first vehicle zone (associated with a rental inquiry) and an area of a second geographic zone that is associated with the given vehicle. In another embodiment, the distance between one or more points in a first geographic zone and one or more points in a second geographic zone may be used to determine vehicle availability. For example, a given vehicle may be determined to be available for rent if an address associated with the vehicle (e.g., the owner's home address or work address) is within a particular distance to a location, address, geographic zone boundary, or other geographic feature specified by a prospective driver relative to a vehicle rental inquiry. (Such geographic features may include, in some embodiments, mass transit routes and/or stations, landmarks, buildings, etc.) Accordingly, in one embodiment, determining one or more vehicles that are available for rent includes making respective distance determinations for at least two vehicles registered in a vehicle rental system (e.g., whether respective geographic zones for the at least two vehicles are within a specified proximity to a first geographic zone associated with a vehicle rental inquiry).

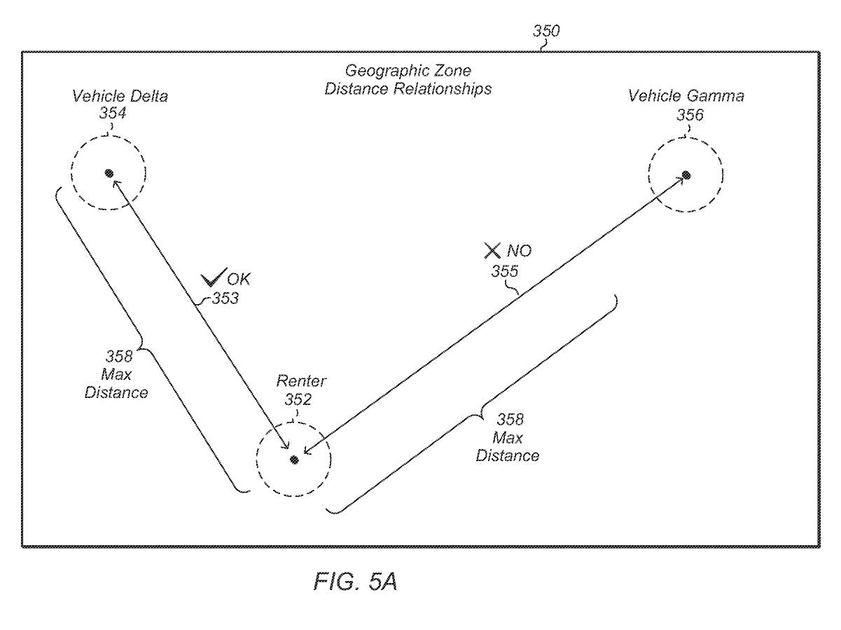

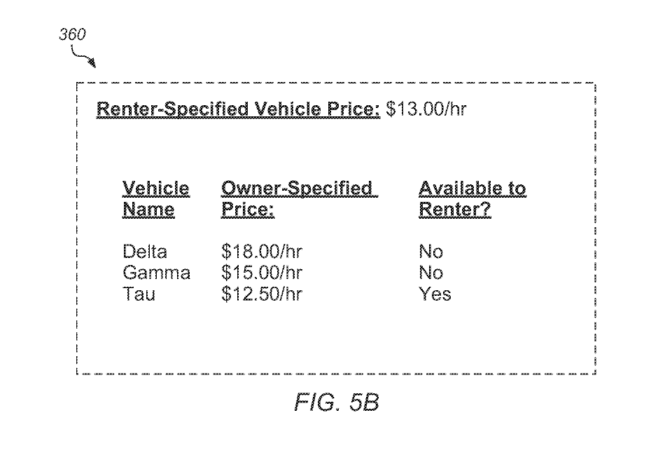

Turning now to FIG. 5A, an example of determining vehicle availability based on a distance relationship is shown. In FIG. 5A, map 350 includes a geographic zone 352 that corresponds to a prospective driver. Two other geographic zones 352 and 354 respectively correspond to Vehicles Delta and Gamma. Reference numeral 358 indicates a specified maximum allowable distance in FIG. 5A.

Distances 353 and 355 respectively indicate distance relationships between the prospective driver and Vehicles Delta and Gamma. As can be seen, distance 353 is less than the maximum allowable distance 358. Accordingly, Vehicle Delta may be determined to be “available” for rental based on the distance relationship that exists between geographic zones 352 and 354. (Note that as shown, distance is measured between center points within zones 352 and 354; however, in other embodiments distance may be measured differently, such as distance between points not in the center of a zone, distance between zone boundary edges, etc.). The distance 355 between center points of zones 352 and 356 in FIG. 5A, however, significantly exceeds the maximum allowable distance 358. Thus, based on the distance relationship between zones 352 and 356, Vehicle Gamma may be determined to be “unavailable” for rental, or prioritized low. In other embodiments, vehicle may be displayed without regard to availability, but simply in a suggested order.

Maximum distance 358 may be specified by an administrator of server 110 in some embodiments, while in another embodiments, a maximum distance may be specified by a prospective driver. Maximum distance 358 may exceed a viewing area of a map such as map 350. That is, in some embodiments, every vehicle positioned within a map may be determined to be available. Other types of distance relationships are also possible in various embodiments. In one embodiment, one or more vehicles are determined to be available for rent simply by determining what vehicles are closest to a location indicated by a prospective driver (e.g., without respect to a particular specified maximum distance). Note that overall vehicle availability may also be based on a variety of other factors 321, and thus simply because a given vehicle meets one availability standard (e.g., for distance) does not mean that particular vehicle will ultimately be determined as available rental after other information is considered by server 110.

Turning back to FIG. 4, discussion of operation 320 is resumed. Operation 320 may also consider pricing information 324 when determining vehicle availability. An owner may specify one or more rental rates for a particular vehicle, for example, while a prospective driver may set a desired price range (or price point) for a rental. If the owner's price for a vehicle does not overlap with the price range of the prospective driver, that vehicle may be determined to be unavailable. In some embodiments, however, price may not be a disqualifying factor for rental availability. Availability based on pricing factors may be determined based on whether a prospective driver's price is above a price criterion specified by the owner, or if the prospective driver's price is within a specified amount (or specified percentage) of the owner's price.

Consider the example of FIG. 5B, in which a diagram 360 illustrates Vehicles Delta, Gamma, and Tau as having respective owner-specified prices of $18.00, $15.00, and $12.50 per hour. Meanwhile, a prospective driver has a specified price point of $13.00 per hour. In this example, Vehicle Tau may be considered available, while Vehicles Delta and Gamma will be considered unavailable for rental. In other embodiments, however, vehicles may be considered available if they are within 25%, or if they are within $5.00/hour, of the prospective driver's desired price point. In such embodiments, Vehicles Delta and/or Gamma might also be determined as being available for rent. Note that in some embodiments, however, vehicle pricing may be considered merely as an optional criterion, and no vehicles will be excluded based on price. (Thus, in some embodiments, determining whether a vehicle is available is not based on price. In such embodiments, price may affect the order in which vehicles are displayed to a prospective driver, however.) Pricing information 324 may also include minimum spending requirements in some embodiments. For example, an owner may specify that a vehicle cannot be rented for any less than a specified amount (e.g., $20.00), regardless of the length of time of the rental period.

In the embodiment of FIG. 4, operation 320 may also determine vehicle availability based on rental date and/or time information 326. For example, a vehicle rental inquiry may specify particular times and/or dates for a rental period. Server 110 may then determine what vehicles (if any) are available for rent during that period. Making this determination for a given vehicle may include checking to see whether that vehicle is already reserved for all or a part of the rental period. Making this determination may also include checking owner-specified criteria for the vehicle, and determining whether the owner has specified that the vehicle is unavailable for all or part of the rental period. For example, consider a vehicle rental inquiry that specifies a rental period starting at 10:00 pm on Sep. 9, 2012, ending at 9:00 am the very next day (on Sep. 10, 2012). If a vehicle owner has specified that a vehicle is unavailable for rent during any portion of this period, the vehicle may be considered unavailable for that particular rental inquiry (e.g., the owner may require use of his own vehicle beginning at 8:00 am, before the end of the specified rental period). An owner may also specify, in some embodiments, limitations on the duration of a reservation that affect availability. For example, an owner may specify that one or more different maximum durations apply to certain dates and/or times of the day. An owner may thus specify in one embodiment that on weekdays, no reservations longer than three hours may be made, and that on weekends, no reservations longer than six hours may be made. Similarly, an owner may also specify a minimum rental time period (e.g., 30 minutes).

Feedback information 328 may also be used by operation 320 to determine vehicle availability. Server 110 is configured, in some embodiments, to collect feedback information regarding drivers, owners, and/or vehicles. Feedback may be collected via one or more web applications in various embodiments.

In one embodiment, feedback may be left by a driver for an owner. A driver may indicate that a particular rental experience was positive or negative, for example. The driver may also quantifiably rate various experiences (such as an overall vehicle rental experience) in some embodiments (e.g., using a scale of 1 to 5 stars). Feedback left for an owner by a driver may include opinions and/or ratings of vehicle cleanliness, accuracy of a vehicle description (which may be owner provided), etc. Feedback may also be left by a driver for a particular vehicle. For example, a driver may provide opinions and/or ratings on ease of operation for a vehicle.

Driver-provided feedback information may be used to determine, in some embodiments, whether a vehicle is considered available for rent. For example, a driver may specify that if an owner (or a vehicle) has an average satisfaction rating of less than 60%, he or she does not wish to consider renting a vehicle owned by that owner. In other embodiments, feedback information regarding an owner and/or a vehicle may be displayed to a driver, but not used to disqualify vehicles (i.e., cause a vehicle to be considered unavailable for rent). In some embodiments, a minimum number of feedbacks must be available for an average rating to be calculated (e.g., server 110 may not consider and/or display feedback information until three or more feedbacks have been received from three different sources—similar remarks also apply to owner feedback concerning drivers).

Owners may also provide feedback in various embodiments. For example, an owner may indicate whether a particular rental experience was positive or negative. The owner may also quantifiably rate various experiences in some embodiments. The owner may provide opinions and/or ratings of driver cleanliness (did the driver leave the vehicle a mess), driver timeliness (did the driver return the vehicle on or before the stated end time of the rental period), etc. In some embodiments, timeliness metrics may also be independently collected by server 110. For example, server 110 may detect whether a vehicle was returned “on time” by communicating with vehicle 105 to determine when a driver has checked-in a vehicle.

Owner (and system) provided feedback may be used to determine whether a vehicle is available for rent in some embodiments. For example, an owner of a Vehicle Zeta may specify a vehicle rental criterion that any driver having a less than 85% (or 3.5 star) overall rating should not be allowed to rent Vehicle Zeta. Accordingly, server 110 may make a determination that Vehicle Zeta is unavailable for a driver with a poor approval rating makes an inquiry.

Feedback information and/or owner-specified feedback rental criteria may relate only to particular vehicles in some embodiments. For example, while an owner may specify that Vehicle Zeta requires an 85% approval rating for a driver, Vehicle Alpha only requires a 60% approval rating for a driver. (Vehicle Zeta may be the owner's prized sports car, for example, while Vehicle Alpha is an aging and decrepit minivan for which the owner has less concern.) An owner may also specify, in some embodiments, different pricing schemes based on feedback information 328. For example, an owner might specify that a base vehicle rental rate should be charged to drivers with approval ratings of 80% or higher. For drivers between 65% and 80% however, another higher rate might be charged (either as an additional flat fee, as a percentage, etc.). For drivers between 50% and 65%, a higher fee yet still might be charged, while drivers under 50% might be disqualified. Such a scheme allows an owner to essentially charge a “risk premium” to drivers who are perceived to be less desirable.

Operation 320 of FIG. 4 may also determine vehicle availability based on other information 330. In one embodiment, an owner may specify one or more mileage restrictions associated with a vehicle. If a vehicle rental inquiry includes information indicating that the mileage restriction would be exceeded, then that vehicle may be determined unavailable in operation 320. An owner may also specify one or more vehicle proficiency requirements. For example, an owner may specify that a driver must have proficiency with a manual transmission in order to rent a particular vehicle. If a driver does not possess such proficiency (or proof of such proficiency has not been provided to server 110), a particular vehicle may be determined to be unavailable. An owner may specify a requirement for an in-state driver's license (e.g., an owner who lives in Berkeley, Calif. will not allow a driver with an Indiana license to rent a vehicle). An owner may specify a minimum experience requirement as well, for example, requiring that a driver have five or more years continually licensed experience as a driver (or that a driver have a certain length of experience with a manual transmission or other proficiency based requirement). Similar restrictions may be imposed by an operator of server 110 (e.g., WHEELZ), for example, due to insurance or other business requirements.

In one embodiment, the shared rental vehicle network status can be made available for network administrators or Agents. Accordingly, Agent home pages one may be able to access all user accounts for changes including adding a member NFC card number or credit card number, view current reservations, change, cancel, extend, transfer or make reservations, etc. Generally, in various embodiments, an administrator may specify requirements, make changes, view payment information, and collect and/or maintain data regarding the operation of the system.

The existence of one or more specified relationship types between a prospective driver and a vehicle owner is also used to determine vehicle availability in some embodiments. An owner may specify, for example, that a driver must belong to (or be affiliated with) a same organization as the owner. This organization may be a school such as a university, a civic organization, a church, an employer, a housing unit (e.g., a shared apartment complex or household in which the owner and driver live), a volunteer group, public or private club, or other type of organization. Accordingly, in one embodiment, an owner may specify that only students, staff, or faculty of a given university may be eligible to rent a particular vehicle. An owner may also specify a sub-group of an organization as a vehicle rental criterion. For example, an owner that works for a large company might specify that a prospective driver must work in a particular facility (e.g., the same one as the owner), or within a particular department or division of the company. Similar restrictions may be imposed by an operator of server 110 (e.g., WHEELZ), for example, due to insurance or other business requirements.

Relationships on a social networking site may also be used to determine if a particular vehicle will be available to a prospective driver. In one embodiment, a prospective driver is eligible to rent a vehicle if the owner and the driver have an existing relationship on a site such as FACEBOOK.COM, TWITTER.COM, LINKEDIN.COM, etc. For example, an owner may specify that only a “friend” on FACEBOOK.COM is allowed to rent a vehicle, while others who are not “friends” with the owner cannot rent the vehicle. Additional variations are possible, particularly if two or more different types of relationship may be supported by a social networking site. Continuing the examples above relative to FACEBOOK.COM, an owner might instead allow “friends of friends” to rent a vehicle, or conversely, might be more restrictive and allow only “close friends” and/or family to rent a vehicle. In some embodiments, an owner can also individually specify which persons should be allowed to rent a vehicle. An owner may specify particular criteria for different individuals and/or groups in some embodiments. An owner might specify that family members under the age of 25, for example, are not allowed to rent a vehicle between 10:00 pm and 7:00 am. Further, in general, any of the vehicle rental criteria described herein and above may be applied differently to one or more different groups and/or individuals. E.g., an owner might specify different pricing, different maximum rental period lengths, and in general may customize any one or more vehicle rental criteria as desired. For example, one or more requirements may be waived, one or more additional requirements may be imposed, and one or more existing requirements may be modified. Note that generally, in some embodiments, vehicle criteria or requirements may be specified by an operator such as WHEELZ or another third party (e.g., insurance companies or a government entity).

In some embodiments, setting vehicle rental criteria for particular individuals and/or groups may be done via an application designed for use with a social networking site. Accordingly, in one embodiment, a particular application designed for use with FACEBOOK.COM may be used to set vehicle rental criteria. Note that the previously discussed examples are in no way limited to FACEBOOK.COM, however, and techniques in accordance with this disclosure may be applied to other social networking websites as may occur to one of skill in the art. In some embodiments, multiple different social networking websites may be supported (e.g., an owner might use information from FACEBOOK.COM to set some vehicle rental criteria, while using information from LINKEDIN.COM to set other vehicle rental criteria).

Thus, any of factors 322-330 may be specified by an owner as one or more criteria that have a bearing on whether a vehicle is determined to be available in response to a given rental inquiry. In addition, any of the foregoing factors 322-330 (or other factors affecting availability) may also be specified by an administrator of server 110 or another third party, in various embodiments. For example, state or federal regulations may require that current state minimum liability insurance be carried by a driver, even though a party having an ownership interest in a vehicle rental system implemented by server 110 may also carry its own blanket insurance policy covering all drivers and/or vehicle owners. Other regulatory and/or third party requirements may also affect vehicle availability.

In operation 335, as shown in FIG. 4, information specifying one or more vehicles is transmitted. In one embodiment, this information specifies vehicles that have been determined to be available in operation 320. In other embodiments, vehicle information may be transmitted even if availability status is uncertain or negative (such as when a vehicle is unavailable for all or a portion of a rental period). In some embodiments, a given vehicle may be “determined to be available” even if it fails to satisfy one or more specified rental criteria. If an otherwise suitable vehicle is available for only a portion of a specified rental period, but not the entire rental period, for example, a prospective driver might still be informed about the vehicle, but also given an indication of its partial unavailability. This could allow the prospective driver to change the rental period, for example, to one that satisfies the owner's preferences and/or the previous reservations. Accordingly, operation 335 may cause information to be transmitted to a user computing device 120 in response to a vehicle inquiry in some embodiments.

The transmission of information specifying one or more vehicles may cause a graphical display of one or vehicles determined to be available for rent. Upon receipt of such information, for example, a user computing device 120 may display graphics on its screen in a format identical or similar to that of maps 190 and/or 255 (e.g. as described above relative to FIG. 2B and FIG. 3). In one embodiment, a web browser of user computing device 120 is configured to display, in graphical format, the received information specifying one or more vehicles.

The displayed one or more vehicles may be ordered according to respective distances to a geographic zone associated with a vehicle rental inquiry. For example, a screen may present a numbered list, with #1 corresponding to the closest vehicle, #2 corresponding to the next-closest vehicle, etc. In accordance with such a list, the vehicles may also be displayed on a map such as map 190. Thus in one embodiment, vehicles may be (graphically) displayed in an ordering based on a driver's location (such as a specified address or an address of record). In such an embodiment, a driver's location or geographic zone (such as a “home zone”) may be used as the basis for determining the vehicle ordering. The vehicles themselves may be ordered according to their own geographic zone (or “home zone”) locations. Note that in one embodiment, however, the term “home zone” explicitly refers to a vehicle's typical parking area(s), and not other locations.

In some embodiments, vehicles may be excluded from a display of available vehicles based on server 110 determining that a vehicle is unavailable (or likely to be unavailable) for a particular rental period. For example, if a vehicle is currently being operated 50 miles from its home zone, but a driver wants to start a rental period in one hour, server 110 may exclude that vehicle from the search results. In making such a determination as to whether a vehicle should be excluded for search results based on distance, server 110 may employ techniques similar to those described below with respect to estimated travel times, etc.

In some embodiments, for each vehicle, an indication of time period availability for that vehicle may be shown. For example, a graphical bar may be shown for each vehicle that covers a 24 hour period, with coloring or shading to indicate availability and unavailability. E.g., in one embodiment, a bar is shaded one color according to intervals to show times that it is busy, while it is shaded another color to show that it is free. Accordingly, in various embodiments, one or more vehicles satisfying a distance relationship and/or other relationships may be displayed to a user simultaneously via a graphical interface.

With continued reference to FIG. 4, in operation 340, information specifying a selection of a particular vehicle may be received. In one embodiment, operation 340 is caused by a prospective driver using a computing device 120 clicking on (or otherwise selecting) a given vehicle that fits prospective rental criteria. Computing device 120 may then transmit this information to server 110. Other information for a vehicle reservation may also be transferred in operation 340 in various embodiments.

In operation 345, a particular vehicle may then be reserved. Reserving a particular vehicle may include updating a central database at server 110 to reflect that the vehicle will be unavailable to other drivers during the rental period. Reserving a vehicle in operation 345 may also include, in some embodiments, the driver making full or partial payment for the period of the rental. A deposit (either refundable or non-refundable) may be collected by server 110, in various embodiments, via credit card, ACH bank draft, PAYPAL payment, or other payment mechanism as will occur to one of skill in the art.

Upon reservation of the vehicle, its owner may be notified via SMS (text message), email, telephone call, etc. Notification to the owner may include the dates and/or times of the rental period, an identification of the vehicle being rented, the amount or estimated amount being charged for the rental, an identity of the driver for the vehicle, and/or any other information that may pertain to a rental period as described herein. Similar notifications may also be sent to a driver. In one embodiment, reserving a vehicle in operation 345 may cause content to be published on a social networking website. For example, if a driver John reserves a vehicle from his FACEBOOK friend Sally, a story may be published to the FACEBOOK account of John and/or Sally advertising this fact. Such a story may be helpful to alerting other FACEBOOK users that one of their friends allows their vehicle to be rented out, and may direct traffic to a website such as WHEELZ.COM. Likewise, similar messages may be sent upon the vehicle being checked back after a reservation, or may be sent when a driver or owner changes (or cancels) a reservation. Reminder messages may also be sent to an owner and/or driver in association with an upcoming rental—for example, server 110 may send a text message to an owner or driver at a predetermined time (e.g. one hour before a rental begins). Messages may also be sent with an offer to extend a current (active) reservation, in some embodiments.

In some embodiments, a vehicle driver may elect to cancel a reservation. This ability may be subject to certain constraints and/or fees in one or more embodiments. For example, in some embodiments, a driver may be forbidden from canceling a reservation less than four hours (or some other specified amount time) in advance of the reservation. In some cases where a vehicle is scheduled to be dropped off at a particular location that was not the start location—i.e., if a next driver is depending on the vehicle being in a different area later that day—canceling could also be prohibited. A warning or fee could be issued to a driver by a vehicle rental system implemented on server 110. If a sufficient number of reservations are canceled by a driver or are missed, or if negative feedback is received, in some embodiments, a driver could be temporarily or permanently banned from the vehicle reservation system. In one embodiment, a driver may have to pay all or a portion of the costs for cancellation (which could include a price difference for another driver's increased cost for having to rent a more expensive vehicle instead).

In some embodiments, an owner may drive his or her own vehicle at any time without a prior reservation. In such embodiments, a vehicle 105 may automatically become reserved in response to the owner's use. For example, in response to a vehicle 105 being started without a reservation, server 110 may reserve the vehicle in the system (marking it as unavailable for rental) for a period of one hour, or some other default period of time. The time period in which the vehicle is considered unavailable for rental may be updated throughout the day as the owner continues to use his vehicle (i.e., operating it without checking it back into a geographic zone which the owner has specified for rental of the vehicle). In some embodiments, if a vehicle 105 is put into operation (e.g., the ignition is turned on) without a prior reservation, the owner may receive an alert in the form of a text message or other format. The alert may tell the owner whether an upcoming rental for the vehicle exists, and/or may inform the owner that the current use of the vehicle may negatively affect the upcoming rental. For example, if the owner starts the car less than 30 minutes (or other amount of time) before an upcoming rental period starts, such an alert may be sent. An alert message sent to the owner may also, in some embodiments, server to alert the owner to unauthorized use of the vehicle.

### Vehicle Hardware

Turning now to FIG. 6, a block diagram illustrating an overview of an exemplary hardware configuration 400 for a vehicle 105 is shown. As will be described, vehicle hardware 400 allows a vehicle to communicate with various external systems and allows control of certain vehicle hardware functions. Any communication that is described as being sent (or received) by vehicle 105, in various embodiments herein, may be transmitted to (or received from) server 110 using hardware 400. Communications may also be sent directly between vehicle 105 and an owner, driver, or other party. Accordingly, in some embodiments, any communication described as being sent from vehicle 105 may be sent directly to (or received directly from) an owner, driver, or other party without having to be relayed through server 110, while in other embodiments, some or all such communications may be relayed through server 110. In one embodiment, functionality described with respect to server 110 (e.g., such as relating to vehicle communication) may thus be implemented, wholly or in part, by software running on a user computing device 120. Communications be sent from hardware 400 to vehicle systems such as doors and lights, in some embodiments.

As shown in FIG. 6, vehicle system hardware 400 includes a processor 402, a radio unit 405, a GPS (global positioning system) unit 410, an NFC (near field communication) unit 415, a RFID (radio frequency identification) unit 420, vehicle-customer interface unit(s) 425, and a computer-readable storage medium 430. In the embodiment shown, processor 402 is configured to communicate with units 405-425 and storage medium 430 via one or more busses, network connections, serial links, and/or other techniques and structures as would occur to a person of skill in the art. Computer-readable storage medium 430 may store instructions, in some embodiments, that are executable by processor 402 to cause units 405-425 to perform various actions. A USB port 435 in one embodiment can be used for transferring data (such as software) or testing a hardware unit. Bluetooth unit 422 may also be present in some embodiments and is usable to communicate with suitably enabled devices.

Units 405-425 may receive external stimuli (e.g., radio broadcasts, satellite signals, electrical impulses from vehicle hardware, etc.). Storage medium 430 may also include various instructions that are executed in response to such stimuli. That is, any of units 405-425 may cause certain instructions on storage medium 430 to be executed. Other processors and/or computer-readable media (not depicted) may be included within units 405-425, and in some embodiments, one or more of units 405-425 may be integrated into a single device, single, circuit, or other integrated hardware. The configuration illustrated in FIG. 6 is merely one embodiment, however, and other configurations are possible.

Radio unit 405 is configured to send and receive communications via one or more wireless networks. In some embodiments, radio unit 405 may be configured to use a wireless mobile telephone data network. Accordingly, in one embodiment, radio unit 405 is a GSM enabled unit that is configured to connect to a GSM data network. Meanwhile, GPS unit 410, is configured to determine a location of vehicle 105 by communicating with a GPS system. The location of vehicle 105 may, in turn, be communicated to server 110 (or a driver, owner, or other party) via radio unit 405.

In some embodiments, vehicle location may be determined using techniques other than GPS. For example, radio triangulation (via radio unit 405) or other radio techniques may be used to determine a vehicle's location. In yet other embodiments, a vehicle location may be specified by an owner or driver. For example, if the vehicle is in a parking garage or other location where wireless reception is poor, an owner or driver might use a web application running on server 110 to specify the particular location of the vehicle by giving a street address and/or additional identifying information. This additional information might include the level or zone of a parking garage that the vehicle is on, one or more access codes to get into a secured parking area, or other details helpful to determining the vehicle's precise location. (Such information may be provided in any event, even when a vehicle's location is not obscured from GPS or radio location, for example).

In the embodiment of FIG. 6, NFC unit 415 allows vehicle 105 to exchange information via a shorter range wireless connection. For example, NFC unit 415 may transmit information to or receive information from a smartphone (or other NFC enabled device) of an owner or driver. Similarly, RFID unit 420 may also be configured to read and/or transmit RFID information at shorter wireless distances. In other embodiments, a BLUETOOTH unit may also be present in vehicle hardware 400 to allow communication with other computing devices (e.g., smartphones). A BLUETOOTH unit may be used in place of (or in parallel with) an NFC unit in various embodiments.

Reservation information may be transmitted to vehicle 105 via radio unit 405 and/or NFC unit 415 in various embodiments. In some embodiments, server 110 periodically transmits updated reservation information to vehicles (e.g., at one or more scheduled times). In one embodiment, server 110 is configured to send only a “delta” of changed reservation information, e.g., only information that has been changed since a previous update is sent. The received reservation information may include dates, times, driver identities, security credentials for one or more drivers (e.g., to ensure that only an authorized driver can unlock and operate a vehicle), location or geographic zone information (e.g., what zone(s) a vehicle is supposed to be in for the start and/or end of a particular reservation), or other information. Reservation information can thus be “pushed” from server 110 to vehicles 105 via radio unit 405. In various embodiments, reservation is digitally signed by server 110 and can be verified by a vehicle 105. Reservation information can also be transferred via NFC unit 415 in some embodiments. For example, an NFC enabled smartphone might be loaded with reservation information from server 110, and then the NFC enabled smartphone is used to download the information to a vehicle. Such techniques may be helpful if a vehicle is not in radio communication with server 110, for example.

Turning now to FIG. 7, a block diagram 450 is shown depicting exemplary vehicle-customer interface units that correspond to vehicle-customer interface units 425 in at least one embodiment. As shown, diagram 450 includes horn interface unit 455, lock interface unit 460, and ignition unit 465, all connected via a bus 470 (which, in turn, may be connected to processor 402). In some embodiments, vehicle hardware 400 may also include a dynamic learning unit (DLU) 475 and a human-machine interface unit 478. In some embodiments, the interface units 455-465 may include a DC battery unit interface (not depicted) and a lights interface unit (not depicted.) These units may respectively provide access to power and access to vehicle lighting functions.

The configuration of interface units 455-465 and bus 470 may vary in different embodiments depending on the particular vehicle in which they are installed. For example, a large variety of different electronic busses and/or communication systems may be used to connect processor 402 to actual vehicle hardware (the horn, locks, and ignition, for example). Vehicle communication protocols may include FlexRay, J1850 Bus, SMARTwireX, IDB-1394, IEBus, LIN Bus, CAN Bus, Intellibus, Vehicle Area Network, and any other bus and/or communication system that may be used by one of skill in the art. In some embodiments, multiple busses, communication systems, and/or interconnects may be used to link interface units 455-465 to processor 402.

Interface units 455-465, in various embodiments, include actuators designed to operate the vehicle hardware. Accordingly, horn interface unit 455 includes one or more actuators configured to start (and cease) a vehicle's horn in one embodiment. In one embodiment, horn interface unit 455 may be used in order to locate a vehicle. A driver (or owner) that is attempting to precisely locate a given vehicle may find it useful to hear the vehicle's horn so that he or she can use the horn's sound to “home in” on the vehicle's location. For example, if a driver is attempting to locate an unfamiliar vehicle in a crowded area such as a shopping mall parking lot, being able to remotely control the vehicle's horn may be quite useful. Thus, in one embodiment, a driver can use a portable computing device to send an instruction that is received by the vehicle and sent to horn interface unit 455 to cause the vehicle's horn to sound. In some embodiments, a driver can only use the vehicle's horn if he currently has the vehicle reserved, or if he is within a specified amount of time prior to his rental beginning (e.g., within 5 or 10 minutes from the beginning of the rental period). In some embodiments, an owner may remotely use the horn interface unit at any time (or at any time the vehicle's ignition is not turned on). The light interface unit may, in one embodiment, be used to locate a vehicle at night be causing the parking lights, headlights, interior vehicle light, or other lights to be operated (for example, in response a command from a driver's portable computing device).

Lock interface unit 460 includes one or more actuators to lock and/or unlock vehicle doors, trunks, hoods, storage compartments, or other locks on the vehicle, in various embodiments. In one embodiment, a vehicle can be unlocked via user computing device 120. For example, an RFID unit or NFC unit may detect the presence of an authorized computing device that corresponds to a driver who has the vehicle reserved for a current rental period, and communicate with lock interface unit 460 to cause the vehicle's doors to become unlocked. In another embodiment, a vehicle may receive an indication via a wireless data network (e.g., a GSM mobile phone network) that a vehicle should be unlocked. For example, a driver who is within an authorized rental period might send a text message to server 110 (or use a web interface or other communication means) to cause the vehicle to become unlocked. In one embodiment, lock interface unit may control one or more storage compartments (trunk, glove box, etc.) within the vehicle. A storage compartment might contain a key for the ignition, for example, in some embodiments. In other embodiments, one or more storage compartments may be inaccessible to some and/or all drivers, depending on owner specified preferences.

In some embodiments, lock interface unit 460 may receive authorization to unlock the vehicle from server 110. That is, server 110 may authenticate a driver or owner, and then transmit an unlock command to a vehicle 105. In other embodiments, a vehicle 105 may be unlocked without direct contemporaneous communication from server 110. For example, an NFC unit may detect a driver's authorized smartphone, but because the vehicle is parked in an underground parking garage, cannot contact server 110. However, the vehicle may have previously received reservation information from server 110 that indicated the NFC of the authorized smartphone. Vehicle 105 may thus be unlocked based on stored information. In yet another embodiment, vehicle 105 may be unlocked solely based on information contained in a portable device (e.g., without prior radio communication with server 110). For example, a user smartphone may be programmed with downloaded reservation data indicating that a vehicle has been rented for a particular period. Server 110 may digitally sign this reservation data to provide for its authenticity. Upon a vehicle determining that the digitally signed reservation data is authentic, the vehicle may be unlocked and/or started even though no communication with server 110 has occurred via radio unit 405. (Accordingly, in various embodiments, server 110 may be configured to encrypt and/or digitally sign all communications sent to a vehicle, owner, driver, or other party, whatever the form of the communication).

In other embodiments, a “key exchange” model may be used, in which vehicle keys are physically exchanged between drivers (or between drivers and a service operator such as WHEELZ or a trusted third party). Accordingly, some or all of the vehicle hardware units may not be present in various embodiments. For example, having a lock interface unit may be unnecessary if a driver is able to unlock the vehicle using a key (or key fob or similar device). Key exchanges may have different formats in accordance with features of this specification. In one key exchange format, a service operator or other party might have a spare copy of a vehicle key, which can then be “checked out” of the key exchange by another driver. For example, a key exchange might be physically located in a central business district, on a college campus, or in another convenient location such that drivers can easily acquire a key and drive a shared vehicle. Key exchanges may be automated without any human personnel required or may have an attendant, in different embodiments. Multiple different types of key exchanges or features thereof can of course be used and combined in different configurations. Another key exchange type involves driver-to-driver key transfer. For example, server 110 could be configured with communication software to help schedule or send a reminder for face to face meetings between drivers for key exchange purposes. In yet other embodiments, key exchange could be performed at a secured “drop” location. For example, a key exchange could be a group of automatic lock boxes in communication with server 110. The lock boxes could be unlocked using a PIN code given to the driver by server 110 (or using some other security protocol).

Accordingly, lock interface unit 460 may not be present in all embodiments. Other vehicle hardware may also not be present in some embodiments. In one embodiment, no aftermarket vehicle hardware of any kind need be installed in order to have a vehicle participate in a car sharing service. Instead, in this embodiment, the owner would register the vehicle in accordance with the requirements of a key exchange protocol that is being used. Scheduling, reservation, etc., could be performed as described in other embodiments. Vehicles might be “checked out” or rented, however, using a computing device (e.g., the smartphone of a driver). Thus, server 110 could learn that a car is in use by communicating with a device controlled by the driver. In some embodiments, the location of the driver's mobile computing device may be tracked (e.g., via GPS or other techniques described herein). In lieu of vehicle hardware specifically configured to determine the vehicle's location, the location of the driver's cell phone could instead be used as a proxy for the vehicle. Other system features described herein may be used in a key exchange model as would be used or adapted by one with skill in the art in a manner consistent with this disclosure.

Ignition interface unit 465 may include one or more actuators configured to sense start the and/or stop status of the vehicle's engine in some embodiments. In some embodiments, ignition interface unit 465 may start the ignition based upon interaction with a user computing device (e.g., via NFC unit 410). Thus in one embodiment, a vehicle may start for a driver via “keyless ignition” in which the user's smartphone is detected to be within proximity (e.g., to the interior of the vehicle). Ignition unit 465 cannot start or stop the vehicle, in one embodiment, unless certain criteria are met (e.g., the vehicle engine may not be started unless an authenticated operator is present; or the vehicle engine may not be turned off unless the vehicle is in park). In some embodiments, ignition interface unit 465 is simply not configured to turn the vehicle engine off (e.g., for safety reasons).

Interface units 455-465 are configured to be installed into a large number of different vehicle types in various embodiments. In some embodiments, at least a portion of interface units 455-465 are installed by a vehicle's manufacturer (i.e., interface units 455-465 may include control systems or other hardware provided by a vehicle manufacturer.) In other embodiments, interface units 455-465 are aftermarket hardware that may be installed in order to equip a vehicle 105 for use in a vehicle rental system.

Because a particular vehicle's hardware may vary depending on make, model, vehicle age, options package(s), and other factors, a large number of different vehicle hardware configurations are possible. Electrical and/or electromechanical communication with vehicle hardware may, in various embodiments, include single or multiple pulses, active high (positive) voltage, active low (negative) voltage, and various other signals. If particular electrical and/or electro-mechanical impulses needed to control one or more pieces of vehicle hardware are unknown, dynamic learning unit 475 may be used to determine the necessary signals in some embodiments.

### Learning Vehicle Hardware Control(s)

DLU 475 is configured, in at least one embodiment, to dynamically learn what signals may be needed to control particular vehicle hardware. DLU 475 is configured with a learning mode in this embodiment, in which DLU 475 observes vehicle hardware functions in order to discover what signals may control various vehicle hardware components. In this learning mode, DLU 475 may be connected to one or more of interface units 455-465, bus 470, and/or may be connected directly to the vehicle's actual hardware. A human user may then manually perform certain actions to operate vehicle hardware as the DLU observes (and records) the resulting impulses. For example, the human user may instruct the DLU that the next impulses that will be observed correspond to a vehicle's “unlock all doors” button. (Information may be communicated to the DLU via a portable computing device such as a smart phone, or via a direct interface attached the DLU, in various embodiments). After the DLU is informed that a vehicle hardware function is about to be performed, it will then monitor a bus (or other electrical and/or electromechanical systems) to observe what particular signals are used. Continuing this example, the human user may then press the “unlock all doors” button while the DLU records the resulting impulses that are observed. After the vehicle's doors are unlocked, the human user may then issue an instruction to the DLU that the hardware operation has completed. The DLU may then stop observing (and recording).

Thus, a dynamic learning process may be used by the DLU to learn the operation of vehicle hardware. This dynamic learning process may be applied for any functions relevant to interface units 455-465 (e.g., unlocking one or more doors, using the horn, controlling the ignition). In various embodiments, the dynamic learning process may be performed in association with installation of vehicle hardware 400 (for example, as part of a registration process for a vehicle 105).

In other embodiments, the dynamic learning process used by DLU 475 may include performing partially or fully automated tests to determine one or more vehicle hardware controls. The DLU will thus systematically attempt to use a variety of different signals in one embodiment to control the vehicle hardware. In this embodiment, upon detecting a success, the DLU will record the signal(s) that caused the hardware to operate successfully. It may therefore be sufficient, in some embodiments, to connect the DLU to vehicle hardware, interface units, and/or busses, and simply allow it to perform testing in an automated fashion (e.g., without human interaction). In other embodiments, DLU 475 may automatically attempt a variety of different signals to control hardware, but rely on a human to detect whether success has occurred. Thus, the DLU may send a series of one or more signals to a vehicle's horn, for example, but will rely on a human operator to inform the DLU that the horn has actually sounded. In some embodiments, different types of learning modes may be combined and/or used together for a same vehicle to determine various hardware functions.

DLU 475 is thus configured, in some embodiments, to learn impulses needed to control hardware for particular types of vehicles 105. DLU 475 may, in turn, cause interface units 455-465 to be programmed according to the learned hardware impulse signals in some embodiments (and DLU 475 may also control and/or operate hardware in conjunction with interface units 455-465, in various embodiments). DLU 475 and vehicle-customer interface units 455-465 may each include one or more processors, computer-readable media (which may have stored instructions), and electrical and/or electro-mechanical input and output connections.

DLU 475 may be configured to communicate with server 110 in regard to vehicle configuration information. In one embodiment, DLU 475 is configured to upload vehicle configuration information to server 110. After DLU 475 has dynamically learned one or more hardware control signals for a vehicle 105, server 110 may query DLU 475 to determine what particular signals are being used to control vehicle hardware (though in other embodiments, DLU may upload information to server 110 without being queried). DLU 475 may then transmit vehicle configuration information including information specifying one or more control signals to server 110. Server 110 may then store this information in a database for future use.

Identifying information may also be transmitted to server 110 in association with the vehicle configuration information, so that server 110 knows what kind of vehicle is being used with particular hardware signals (e.g., vehicle 105 may transmit a VIN or other information usable to determine a vehicle make and/or model). In other embodiments, server 110 may simply receive vehicle configuration information and then correlate that information with other stored information to determine the vehicle's identity and type. For example, server 110 may determine the identity of a vehicle 105 based on a GSM identifier, or other identifying information, and use this identity as a key within its information database.

In some embodiments, DLU 475 is therefore configured to download vehicle configuration information that is stored at server 110 (and thus, DLU 475 may learn one or more hardware control signals via such a download). DLU 475 may download configuration information automatically (without interaction by a human user), or may download information in response to one or more user commands. As such, in various embodiments, server 110 may maintain a library of vehicle configuration information for different vehicles so that different DLUs can download information for a particular vehicle in which they are installed. In some embodiments, the library of vehicle configuration information exists as a vehicle configuration database. Configuration information may be stored in such a database by techniques other than dynamic learning; that is, in some embodiments a vehicle configuration database at server 110 may include configuration information acquired from one or more outside sources, such as vehicle manufacturers or third parties.

As one example of vehicle hardware configuration, consider that a first DLU 475 may learn the correct impulses to control one or more hardware functions of a 2004 FORD MUSTANG. A second DLU 475 may later be installed into a different 2004 FORD MUSTANG. Rather than the second DLU having to re-learn the impulses needed for hardware control, however, the second DLU may simply receive downloaded configuration information from a vehicle configuration database of server 110. In yet another embodiment, hardware configuration information may be downloaded to a vehicle 105 via a smart card and/or an NFC enabled device.

### Other Hardware Related Aspects

In the embodiment of FIG. 7, human-machine interface unit 478 includes one or more interfaces to allow a human to interact with DLU 475 and/or other vehicle hardware 400. In various embodiments, human-machine interface unit 478 may include a touch screen display and/or a non-touch screen display, a speaker, a microphone, a video camera (e.g., a web cam), input means such as a keyboard and/or other buttons. Human-machine interface unit 478 may include a processor and a computer-readable storage medium having stored software operable to run the interface unit. Human-machine interface unit 478 may thus have any or all of the characteristics of a user computing device 120 in some embodiments. In one embodiment, human-machine interface unit 478 allows a human (e.g., an owner or driver) to communicate with server 110 (e.g., via radio unit 405).

In some embodiments, ignition interface unit 465 includes an ignition sensor. This ignition sensor is configured to sense whether a vehicle's engine is currently running (i.e., whether the vehicle is in operation). This information may be conveyed to server 110 and/or to an owner, driver, or other party. In some embodiments, server 110 is configured to take one or more particular actions based on received ignition sensor information, as further described below. Accelerometer unit 479 may also be present in some embodiments. This unit may be configured to interface with a vehicle's system so that it can sense whether a car is in motion, how fast the vehicle is going, etc.

### Vehicle Related Messages

As mentioned above, various alerts and other informational messages may be sent in response to vehicle-related actions to an owner, driver, or other party. More particularly, a message may be sent based upon time and/or distance factors in some embodiments (e.g., based on an upcoming rental time, or on a location of a vehicle).

Upon initial booking of a reservation, a confirmation message may be sent to the vehicle's owner and/or the driver. Such a confirmation message may contain any combination of the following details: the particular vehicle being rented (an owner may have multiple vehicles), the time(s) and/or date(s) of the rental period, the geographic start zone and/or geographic end zone for a rental, the total cost to the driver, the profit to the owner, fees and/or taxes being charged to the driver and/or owner; mileage and/or area restrictions for the rental (which may be based on owner preferences), or other information in accordance with embodiments described herein. Any communication sent to an owner and/or driver may take the form of SMS (text message), email, voice telephone call (which may play an automated message), or other forms, in various embodiments.

As the start time for a rental period approaches, different triggers (thresholds) may cause server 110 to send certain messages and/or perform certain actions, as further described below. At one or more specified times prior to a rental, a reminder message may be sent to an owner, future driver, and/or a current vehicle operator (i.e., an owner or a driver who is in the middle of a current rental period). This reminder message, in one embodiment, states that an upcoming rental period is scheduled to begin at a given time and location. Thus, a first reminder might be sent to a current vehicle operator 90 minutes before a next rental period (for a different driver) is set to begin, while 60 minutes before the next rental period, a second reminder might be sent to the person who is next scheduled to rent the vehicle. Many variations are possible, however, and different threshold times may be used in different embodiments. In some embodiments, reminder preferences may be set by an owner and/or driver and stored at server 110.

Meanwhile, in some embodiments, an owner may receive an information message every time a driver starts and/or completes a vehicle rental. This information message may include start time, stop time, start location, and/or stop location. For example, an owner may receive a text (SMS) message that states “Your 2002 JEEP CHEROKEE has been picked up from Palo Alto, Calif., and is now in use by John Q. Smith.” Likewise, upon completion of a rental period, the owner may receive another text message stating “Your 2002 JEEP CHEROKEE has been dropped off at 910 Main St., Palo Alto, Calif., and is no longer in use.” Such a “rental completion” message may depend on server 110 determining that the rental has ended.

Messages may also be sent as a function of distance in various embodiments. In some embodiments, a current operator will receive a warning message in response to being venturing outside a given geographic boundary for the rental (which may be specified by the owner), or for approaching or exceeding a mileage limit for the rental (which may also be owner specified). Such a warning may be delivered via interface unit 478, or via a mobile phone, for example.

### Vehicle Actions Based on Real-Time Location Information

Messages may also be based on vehicle location. Indeed, server 110 and/or vehicle 105 may be configured to cause a variety of different actions (including messaging) to be performed in response to information updates regarding vehicle position and/or vehicle use in some embodiments. Information updates may be provided substantially in real time in some embodiments, while in other embodiments, information updates may be provided on a scheduled or periodic basis. Thus in one embodiment, information may be collected by vehicle hardware and updated periodically. Vehicle 105 may autonomously report information (e.g., without prompting from server 110) and/or may report information in response to a query. Vehicle position may be included in such updates.

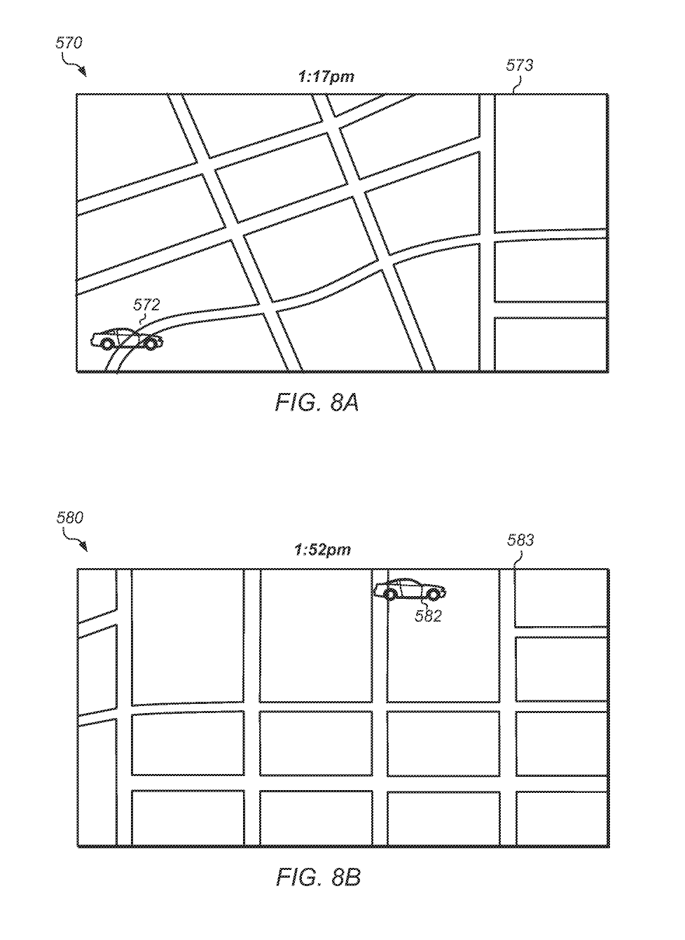

Turning now to FIGS. 8A-8B, two diagrams 570 and 580 are shown. Collectively, these diagrams illustrate an example of how server 110 may receive location information for a vehicle. In FIG. 8A, a vehicle is shown at a location 572 relative to a map 573. In this figure, location 572 corresponds to the vehicle's location at time 1:17 pm. This location may be determined via GPS, for example. Vehicle location 572 may be determined substantially in real time in response to a query from server 110 in some embodiments, or it may be determined by the vehicle without a query from the server in other embodiments (e.g., on a schedule, such as every 5 minutes, or every 10 minutes, etc.). Location information describing position 572 may be transmitted to server 110 after it is determined. Thus, server 110 will become informed of the vehicle's position at a particular time.

In FIG. 8B, a different vehicle location 582 (for the same vehicle as FIG. 8A) is shown relative to map 583. In this figure, location 582 corresponds to the vehicle's location at a later time 1:52 pm. After location 582 is determined (e.g., by GPS), the vehicle may transmit this information to server 110. Accordingly, in various embodiments, server 110 may receive periodic updates on a vehicle's location, which may or may not be delivered in response to a query sent by server 110.

In some embodiments, a user interface may thus be provided to show the locations of one or more vehicles. Such an interface may also display locations of owners and/or drivers (e.g., a user's smartphone may upload its GPS location to server 110 in some embodiments). This interface may be provided via a web application implemented by server 110 in some embodiments. In one embodiment, the interface simply shows locations from which vehicles may be rented (e.g., vehicle home zones). In another embodiment, however, a user may be able to see up to date location information on one or more vehicles. For example, a driver that has an upcoming rental (within 60 minutes, for example) may be able to see a recent or current GPS location of the vehicle he or she has rented via a user interface. This may be helpful to reassure the driver that a vehicle is in the location it is supposed to be, or to let a driver see that a vehicle is currently being driven back to where the driver expects to pick it up. Conversely, the driver may also be able to see that the vehicle is not located where it should be, or that based on distance and/or time, the vehicle may not make it back to the rental area on time (e.g., the driver expecting to pick up a car in downtown San Francisco may see that with only 30 minutes until the start of the reservation, the vehicle is located in San Jose). The interface may also include an indication, in some embodiments, of whether the vehicle is currently in use or in motion, and may include a vehicle speed indicator as well. An expected or estimated vehicle arrival time may also be shown (server 110 may calculate this, for example, in accordance with techniques discussed herein). In one embodiment, a vehicle owner may see all of the aforementioned information (location, speed, etc.) at any time. Thus, owners and drivers may have different viewing privileges for such an interface in various embodiments. This interface may be provided via one or more graphical user interfaces, and may include features similar to those described above with respect to FIGS. 8A and 8B and/or other embodiments discussed herein.

### Vehicle Alerts

Various alerts and other informational messages may be sent in response to vehicle-related actions in response to vehicle-related actions to an owner, driver, or other party. More particularly, a message may be sent based upon a location of a vehicle.

As discussed herein, a given vehicle may be reserved for a particular time and place. For example, a driver may have a reservation that begins at 4:15 pm at a particular location (e.g. within a particular geographic zone). If for any reason that vehicle is not checked in (parked) within the geographic zone by 4:15 pm, the next driver will miss at least a portion (if not all) of the time for which he or she had reserved the vehicle. Failure of an owner or previous driver to return a vehicle in time for an upcoming reservation may be caused by a variety of factors, including unexpected delay (e.g., traffic), poor planning, forgetfulness, or other reasons. Accordingly, in some embodiments, messages may be sent to try to avoid this outcome (or to allow a driver to plan accordingly if a rental period is going to be negatively impacted).

Server 110 is configured, in various embodiments, to perform calculations to determine whether it is likely (or certain) that a particular reservation is going to be affected by vehicle unavailability. Server 110 may then alert a driver, owner, or other party with an email, text message, phone call, or other communication.

In one embodiment, server 110 determines that an upcoming reservation may be negatively affected based on time and/or distance factors for the vehicle that is being rented. For example, if the rented vehicle is a certain distance away from its rental geographic zone (the zone in which the vehicle is supposed to be located for an upcoming rental) within too short a time from which the rental is supposed to begin, server 110 may determine that it is unlikely that the vehicle will arrive back at the rental geographic zone in time for the upcoming rental period. Consider a car rental that is scheduled to begin at 4:30 pm for a geographic zone located in downtown San Francisco, Calif. Prior to this rental, at 4:00 pm, server 110 detects that the car is located in eastern San Jose, Calif. As discussed above, vehicle location may be provided periodically, or server 110 may query a vehicle for its location. In one embodiment, server 110 may explicitly query a vehicle because an upcoming reservation for the vehicle is scheduled.

Server 110 may reach a determination, based on estimated distance(s) and estimated vehicle speed(s), that a vehicle is unlikely to reach a particular location by a certain time. In the example above, because downtown San Francisco and eastern San Jose are approximately 45 miles apart by road, it is extremely unlikely (perhaps even impossible) that the current driver of the vehicle at 4:00 pm will be able to get the car all the way to downtown San Francisco for the 4:30 pm start of the upcoming rental period. For this to happen, for example, the car would need to travel at roughly 90 miles per hour to reach San Francisco by 4:30 pm. However, the estimated travel time along the route from San Jose to San Francisco may be approximately 50 minutes (corresponding to a speed of roughly 55 miles per hour). Accordingly, even if the vehicle is in motion at 4:00 pm, server 110 may determine that the car is likely to arrive at least 20 minutes late for the 4:30 pm reservation. As discussed below, server 110 may then send one or more messages based on such a determination.

In some embodiments, approximations of vehicle travel times may be performed by server 110 querying an outside information service (such as MAPQUEST.COM or MAPS.GOOGLE.COM). In other embodiments, approximations of vehicle travel times may be performed by information stored locally on server 110 (e.g., server 110 may maintain its own database usable to calculate travel times). In some embodiments, server 110 receives actual travel information from vehicles 105, such as time of day, vehicle location, and/or vehicle speed. In these embodiments, server 110 may aggregate this received information in its own database, and use this gathered information to make its own estimates of travel times. A threshold amount of acquired data may be required in order to make a travel time estimate in some embodiments (e.g., if server 110 has only observed three trips between San Jose and San Francisco, it may defer to an outside information such as MAPQUEST; however, if fifteen or more trips have been observed, server 110 may use its own data to estimate travel time). Calculations for an estimated vehicle travel time may also vary by time of day in some embodiments. During morning or evening rush hours (for example, 7:00 am to 9:00 am and 4:00 pm to 7:00 pm), a given distance may take longer to travel than usual. Travel times may also be affected by holidays and/or days of the week. Thus, if a 4:30 pm reservation in San Francisco is for a Friday (when rush hour will cause slow traffic), server 110 may estimate a travel time of 100 minutes to reach San Francisco from San Jose (corresponding to an average travel speed of 27 miles per hour). In some embodiments, server 110 may receive real-time traffic information from outside sources (such as a travel advisory or traffic monitoring service) and use this information to detect possible rentals that may be affected. For example, if server 110 determines that one or more highway lanes are closed, or that traffic in a particular area is moving at a particular (slow) speed, it may use this information in calculating an estimated travel time.

Server 110 may also consider whether a vehicle is currently in use (i.e., is being driven) when determining whether an upcoming reservation may be negatively affected. Such information may be gathered, in one embodiment, via an ignition sensor in ignition interface unit 465. Consider a vehicle reservation scheduled to begin at 11:00 am in a geographic zone near the campus of the University of California, Berkeley, for example. At 10:30 am, prior to the start of the reservation, server 110 may determine that the vehicle is located near Richmond, Calif., and further determine that getting the vehicle to the Berkeley campus should take only approximately 15 minutes. However, server 110 may also detect that as of 10:30 am, the ignition of the vehicle is turned off (i.e., the vehicle is parked). Server 110 may thus determine that the upcoming 11:00 am reservation is at (greater) risk of being negatively impacted (because the car would need to be started within the next 15 minutes in order to move it to the Berkeley campus on time). Conversely, if server 110 detects that the vehicle is in operation at 10:30 am (the ignition is already on), it may be assume that the driver is currently en route to where the car is supposed to be located next. Therefore, based on whether a vehicle is currently in use, server 110 may make different judgments about the likelihood that an upcoming reservation will be negatively impacted.

The risk of negative impact to an upcoming reservation may be quantified by server 110 in some embodiments. For example, depending on time and/or distance, server 110 may assign an approximate chance that a vehicle will not be available at the start of a given rental period (i.e., server 110 may assign a value between 0.00 and 1.00 as the likelihood that a car will be available at the rental period start time). In one embodiment, if the vehicle is within a particular geographic zone 30 minutes prior to the rental start period, and the vehicle is not currently being operated (i.e., it is parked), a value of 1.00 might be assigned. Conversely, if a vehicle is located 95 miles away with 30 minutes or less prior to the rental start period, a value of 0.00 might be assigned. In one embodiment, an administrator or operator may estimate that a vehicle in use will negatively impact an upcoming reservation based on the administrator or operator's prior experience.

As noted above, reminders, warnings, and/or other communications may be sent by server 110 (or a vehicle 105) to an owner, driver, current vehicle operator, or other party. Thus, in one embodiment, a location-based determination that a vehicle is unlikely to be ready for a particular upcoming rental may cause an alert message to be sent to a driver. Such a message may include an approximated arrival time, if the vehicle is en route. The driver may be given the mobile phone number of the owner or current operator of the vehicle to contact them and directly inquire about vehicle status in some embodiments.

A driver may also have alternate reservation options provided if a scheduled rental is unable to be completely fulfilled. For example, server 110 may present various options to a user computing device 120, such as allowing the driver to try to re-book the same vehicle at a later time and/or date. The driver may also be prompted to seek rental of another nearby available vehicle, by either the server or an administrator/agent, in some embodiments. In other embodiments, a driver whose reservation is not fully satisfied may receive financial compensation (e.g., a discount on a current or future rental). A driver may also be presented with the option of leaving feedback if a rental is unsuccessful (or, generally, a user may also be presented with feedback options any time a rental is started and/or finished).

In one embodiment, a driver may “add time” to a current rental period. For example, a GUI on interface unit 478 and/or computing device 120 may present a clock to which time can be added. In one embodiment, this may be a circular wheel (e.g., similar to the time face of an analog watch). The user may be able to “dial in” a new amount of time, and may be shown the cost for extending the rental by that period. The driver may also be displayed one or more warnings that the extension of time is not allowed (e.g., the owner has specified return of the vehicle by a certain time or another driver has the vehicle reserved), and the driver may be prevented from extending the current reservation. In some embodiments, drivers may be penalized and/or charged additional costs if they fail to return a vehicle by a specified time. In one embodiment, a user may be presented with a method of contacting an owner or next driver to attempt to negotiate a later return (even if server 110 is currently disallowing such an activity). For example, an owner that is renting his car out to a trusted friend may be receptive to rescheduling his own plans if that friend needs the vehicle for only an additional half hour. In some embodiments, the ability of a driver to contact an owner (or another driver) for such a request may depend on preferences of the other driver and/or owner. Accordingly in one instance, the existence of one or more types of predefined relationships (e.g., on a social networking web site) between the drivers and/or owners may determine whether contact to extend a rental can be initiated.

### Ending Rental Period (Vehicle “Check In”)

Determining that a rental period has been ended may be performed automatically by server 110 in some embodiments. For example, if a vehicle 105 communicates that it is not in use (ignition off) and that it is located in a geographic zone designated for the end of a rental period, server 110 may determine that the vehicle's rental period has been completed. In some embodiments, this determination may also be based on whether the current time is less than a specified amount before the end of a rental period. For example, if a vehicle is reserved from 2:00 pm to 4:00 pm, server 110 may not assume that the rental has been completed simply the vehicle is not in use at 3:05 pm. However, if the vehicle is not in use at 4:01 pm, server 110 may determine that the rental has been completed.

Determining that a rental period has ended may also be based on a user performing one or more “check in” actions for the vehicle. For example, the user may use human-machine interface unit 478 (or a user computing device 120) to inform server 110 that the vehicle has been checked in to a particular location or geographic zone, and that the rental is complete. This information may be transmitted via a web application running on server 110 in one embodiment. In another embodiment, vehicle 105 may prompt a driver to confirm that a vehicle has been “checked in” and that the rental period is over. For example, if a driver parks the vehicle within a specified amount of time to the end of the rental period (e.g., with less than 15 minutes remaining), human-machine interface unit 478 may prompt the driver—via a sound prompt and/or a visual prompt—to ask the driver if they wish to conclude the rental. If the driver selects “Yes,” server 110 will update the vehicle status to being “checked in” and available for use (i.e., no longer in current use). In some embodiments, server 110 may send a driver a warning or error message if the user attempts to end a rental while the vehicle is located outside of an appropriate geographic zone (i.e., a zone which the owner has designated for vehicle drop-off).

### Exemplary Computer System

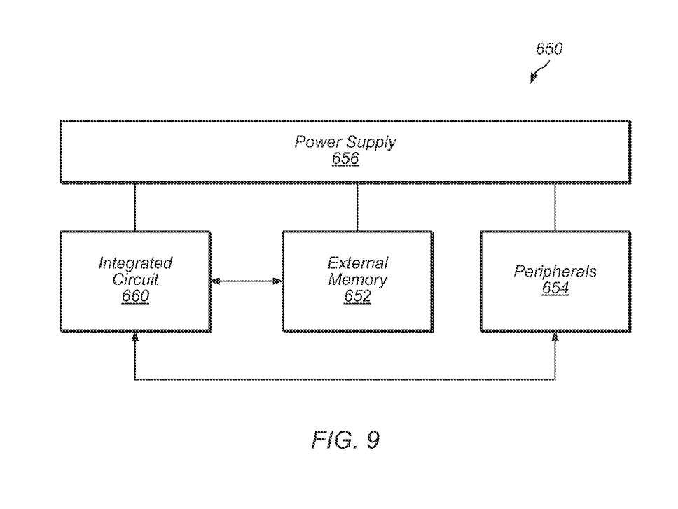

Turning next to FIG. 9, a block diagram of one embodiment of a system 650 is shown. System 650 may be used in various embodiments to implement all or a portion of server system 110, computing devices usable in vehicle 105, and/or computing device 120. In the illustrated embodiment, system 650 includes at least one instance of an integrated circuit (processor) 660 coupled to an external memory 652. The external memory 652 may form a main memory subsystem in one embodiment. The integrated circuit 660 is coupled to one or more peripherals 654 and the external memory 652. A power supply 656 is also provided which supplies one or more supply voltages to the integrated circuit 660 as well as one or more supply voltages to the memory 652 and/or the peripherals 654. In some embodiments, more than one instance of the integrated circuit 660 may be included (and more than one external memory 652 may be included as well).

The memory 652 may be any type of memory, such as dynamic random access memory (DRAM), synchronous DRAM (SDRAM), double data rate (DDR, DDR2, DDR6, etc.) SDRAM (including mobile versions of the SDRAMs such as mDDR6, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit 660 in a chip-on-chip configuration, a package-on-package configuration, or a multi-chip module configuration.

The peripherals 654 may include any desired circuitry, depending on the type of system 650. For example, in one embodiment, the system 650 may be a mobile device (e.g. personal digital assistant (PDA), smart phone, etc.) and the peripherals 654 may include devices for various types of wireless communication, such as wifi, Bluetooth, cellular, global positioning system, etc. The peripherals 654 may also include additional storage, including RAM storage, solid state storage, or disk storage. The peripherals 654 may include user interface devices such as a display screen, including touch display screens or multitouch display screens, keyboard or other input devices, microphones, speakers, etc. In other embodiments, the system 650 may be any type of computing system (e.g. desktop personal computer, server, laptop, workstation, net top etc.). Peripherals 654 may thus include any networking or communication devices necessary to interface two computer systems.

### Computer-Readable Medium

The above-described techniques and methods may be implemented as computer-readable instructions stored on any suitable computer-readable storage medium. As used herein, the term computer-readable storage medium refers to a (nontransitory, tangible) medium that is readable by a computing device or computer system, and includes magnetic, optical, and solid-state storage media such as hard drives, optical disks, DVDs, volatile or nonvolatile RAM devices, holographic storage, programmable memory, etc. The term “non-transitory” as applied to computer-readable media herein is only intended to exclude from claim scope any subject matter that is deemed to be ineligible under 35 U.S.C. §101, such as transitory (intangible) media (e.g., carrier waves), and is not intended to exclude any subject matter otherwise considered to be statutory. Computer-readable storage mediums can be used, in various embodiments, to store instructions and/or data for vehicles 105, server 110, and/or user computing devices 120. In some embodiments, particular functionality may be implemented by one or more software “modules”. A software module may include one or more web applications in some embodiments, and may make use of PHP, JAVASCIPT, HTML, Objective C, JAVA, or any other technology that allows a user computing device 120 to interact with server 110 (for example). In various embodiments, software functionality may be split across one or more modules and/or may be implemented using parallel computing techniques, while in other embodiments, various software functionality may be combined in single modules. Software functionality may be implemented and/or stored on two or more computer systems (e.g., a server farm, or a front-end server and a back-end server and/or other computing devices such as device 120) in some embodiments.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure. Additionally, section or heading titles provided above in the detailed description should not be construed as limiting the disclosure in any way.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

1-60. (canceled)

61. An apparatus usable in a vehicle, comprising:
a processor; and
a memory having instructions stored thereon that are executable by the processor to cause the apparatus to perform operations comprising:
receiving reservation information transmitted by a remote computer system, wherein the reservation information includes information specifying an identity of a driver for the vehicle; and
causing the vehicle to be unlocked in response to a confirmation of the identity of the driver.

62. The apparatus of claim 61, wherein the information specifying the identity of the driver includes an identifier of a portable computing device of the driver.

63. The apparatus of claim 62, wherein the operations further comprise:
confirming the identity of the driver by detecting, via a wireless communication protocol, the identifier of the portable computing device.

64. The apparatus of claim 61, wherein the reservation information includes a start time for a rental period; and
wherein the operations further comprise determining whether to unlock the vehicle based on a comparison of a current time with the start time for the rental period.

65. The apparatus of claim 61, wherein the reservation information includes an end time for a rental period; and
wherein the operations further comprise causing a warning to be issued based on a comparison of a current time with the end time for the rental period and based on the apparatus detecting that the vehicle is currently in operation.

66. The apparatus of claim 65, wherein the warning includes an audible warning.

67. The apparatus of claim 61, wherein the operations further comprise verifying that the remote computer system is authorized to transmit the reservation information to the vehicle.

68. The apparatus of claim 61, wherein the operations further comprise causing a warning to be issued based on a comparison of a current location of the vehicle to a geographic zone specified by an owner of the vehicle.

69. The apparatus of claim 61, wherein the operations further comprise causing a warning to be issued based on a comparison of a distance for which the vehicle has been driven during a current rental period to a distance limit preference specified by an owner of the vehicle.

70. The apparatus of claim 61, wherein the apparatus further includes a lock interface unit, wherein the lock interface unit is configured to cause the vehicle to be unlocked by sending one or more electrical impulses to one or more locking mechanisms of the vehicle.

71. A computer-readable storage medium having instructions stored thereon that are executable to cause a computer system to perform operations comprising:
receiving reservation information transmitted by a remote computer system, wherein the reservation information includes information specifying an identity of a driver for a vehicle, wherein the computer system is configured to couple to one or more electrical systems of the vehicle;
confirming the identity of the driver; and
in response to said confirming, causing the vehicle to be locked or unlocked.

72. The computer-readable storage medium of claim 71, wherein the information specifying the identity of the driver includes an identifier of a portable computing device of the driver.

73. The computer-readable storage medium of claim 72, wherein the operations further comprise:
confirming the identity of the driver by detecting, via a wireless communication protocol, the identifier of the portable computing device.

74. The computer-readable storage medium of claim 71, wherein the operations further comprise:
confirming the identity of the driver by receiving an additional transmission of information from the remote computer system.

75. The computer-readable storage medium of claim 71, wherein causing the vehicle to be unlocked includes causing a lock interface unit to sending one or more electrical impulses to one or more locking mechanisms of the vehicle.

76. The computer-readable storage medium of claim 71, wherein the reservation information includes a start time for a rental period, and wherein the operations further comprise:
determining a current time; and
causing the vehicle to be unlocked based on a comparison of the current time with the start time for the rental period.

77. The computer-readable storage medium of claim 71, wherein the operations further comprise verifying that the remote computer system is authorized to transmit the reservation information to the vehicle.

78. A method, comprising:
receiving reservation information transmitted by a remote computer system, wherein the reservation information is received at a local computer system including a processor and a memory, wherein the reservation information includes information specifying an identity of a driver for a vehicle, and wherein the local computer system is coupled to one or more electrical systems of the vehicle;
the local computer system confirming the identity of the driver; and
in response to said confirming, the local computer system causing the vehicle to be unlocked.

79. The method of claim 78, wherein the information specifying the identity of the driver includes an identifier of a portable computing device of the driver.

80. The method of claim 79, wherein confirming the identity of the driver includes detecting, via a wireless communication protocol, the identifier of the portable computing device.

81-98. (canceled)
